(19) United States
(12) Patent Application Publication
(10) Pub. No.: US 2026/0120285 A1
(43) Pub. Date: Apr. 30, 2026

(54) METHODS AND SYSTEMS FOR BACTERIAL ASSESSMENT

(71) Applicant: First Light Diagnostics, Inc., Chelmsford, MA (US)

(72) Inventors: Don Straus, Cambridge, MA (US); Bruce Walsh, Londonderry, NH (US); Larry Burg, Chelmsford, MA (US)

(21) Appl. No.: 19/371,850

(22) Filed: Oct. 28, 2025

Related U.S. Application Data
(60) Provisional application No. 63/712,857, filed on Oct. 28, 2024.

(51) Int. Cl. G06T 7/00

(52) U.S. Cl. CPC G06T 7/0016; G06T 2207/30072; G06T 2207/30242

(57) ABSTRACT

Disclosed are various embodiments describing methods and systems for bacterial assessment. A computing device can receive a starting first sample image corresponding to a first portion of a biological specimen sample and a starting second sample image corresponding to a second portion of the biological specimen sample. The computing device can also receive a subsequent first sample image corresponding to the first portion and a subsequent second sample image corresponding to the second portion, wherein the second portion is treated with an antibiotic and the first portion is not treated with the antibiotic. Each image can be analyzed to determine a blob count. A growth ratio can be determined based on the blob counts across the starting and subsequent images. The computing device can output an assessment of antibiotic effectiveness for the biological specimen sample based on the calculated growth ratio.

### CROSS-REFERENCE TO RELATED PATENT APPLICATION

This application claims priority to and the benefit of the filing date of U.S. Provisional Patent Application No. 63/712,857, filed Oct. 28, 2024, the entirety of which is hereby incorporated by reference herein.

### BACKGROUND

The diagnosis and treatment of bacterial infections often rely on determining both the identity of the causative organism and its susceptibility to antimicrobial agents. Conventional methods for bacterial identification and antimicrobial susceptibility testing typically require isolation of colonies from patient specimens, followed by culture-based assays, such as broth microdilution or disk diffusion. These approaches can provide reliable results, but generally require extended incubation periods, often ranging from 18 to 48 hours, which may delay the selection of effective therapies. More recent developments have introduced molecular and imaging-based techniques that seek to accelerate testing by directly analyzing clinical specimens. However, challenges remain in balancing speed with accuracy, including ensuring reliable growth assessment in the presence of antibiotics, detecting low concentrations of pathogens, and minimizing interference from specimen matrix effects. Accordingly, there is a continued need for improved methods and systems that provide timely and accurate assessment of bacterial growth and antimicrobial susceptibility.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIG. 1 shows a view of an example cartridge;

FIG. 2 shows a view of an example instrument for performing microbe identification and antibiotic susceptibility testing

FIG. 3 shows an example user interface for displaying antimicrobial susceptibility results:

FIG. 4 shows an example system:

FIG. 5 shows an example flowchart describing functionality for which the example system can perform; and

FIG. 6 shows an example flowchart describing functionality for which the example system can perform.

### DETAILED DESCRIPTION

The disclosed method and compositions may be understood more readily by reference to the following detailed description of particular embodiments included therein and to the Figures and their previous and following description. It is to be understood that the disclosed method and compositions are not limited to specific synthetic methods, specific analytical techniques, or to particular reagents unless otherwise specified, and, as such, may vary. It is also to be understood that the terminology used herein is for the purpose of describing particular embodiments only and is not intended to be limiting.

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C: D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C: D, E, and F; and the example combination A-D. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”. “an”, and “the” include plural reference unless the context clearly dictates otherwise. Thus, for example, reference to “a growth measure” includes a plurality of such growth measures, reference to “the well” is a reference to one or more wells and equivalents thereof known to those skilled in the art, and so forth.

“Abx” is the abbreviation for antibiotic. An antibiotic is a chemical compound that can inhibit bacterial growth, weaken a bacteria's strength, and/or kill or eliminate bacteria. Examples of antibiotics include: Trimethoprim-Sulfamethoxazole, Ciprofloxacin, Cefpodoxime, Nitrofurantoin, Ceftriaxone, Cefazolin, Amoxicillin-Clavulanate, Fosfomycin, Levofloxacin, Meropenem, Ertapenem, Ampicillin, Piperacillin/Tazobactam, Cefepime, Tobramycin, Aztreonam, Linezolid, Vancomycin, Daptomycin.

AST is the abbreviation for Antimicrobial Susceptibility Test. AST can include laboratory procedures (performed by a specialized machine) used to determine how effectively an antimicrobial agent (antibiotic, antifungal, antiviral, etc.) inhibits the growth of a microorganism. AST provides guidance for selecting appropriate therapies and helps detect resistant strains.

Blob, as referred to herein, represents a contiguous bright area in an image on a darker background. In other words, A blob is a contiguous group of pixels within an image that exceed a defined intensity threshold, representing a candidate signal object prior to debris filtering and classification. In some embodiments, a blob can be composed of a group of touching pixels that are above a Pixel Threshold.

Blob Intensity, as referred to herein, can be the sum of the pixel intensity of each pixel in a blob expressed in Pixel Intensity Units. Blob intensity can be the quantitative measure of the total fluorescent signal from all pixels that comprise a blob, calculated as the sum of pixel intensities above the defined threshold. Blob intensity can be used to characterize detected objects, distinguish valid analyte signals from debris, and normalize results against the expected intensity of a single labeled cell or particle.

Compactness can be considered a shape-related metric that reflects how closely the area of a detected blob approximates a geometrically compact form, such as a circle. Compactness may be calculated from relationships between a blob's perimeter and area, and it can be used to help distinguish expected analyte signals from irregularly shaped debris. Values for compactness can be a minimum value of 1 for a round blob and a higher value as the ratio of perimeter to area increases.

A debris rule can be described as a predefined criterion applied during image analysis that helps distinguish valid analyte blobs from unwanted objects. Debris rules may use one or more metrics such as blob size, total or average intensity, and shape descriptors (e.g., compactness or elongation) to identify blobs that are inconsistent with expected target characteristics. Blobs flagged by debris rules can be excluded from further analysis so that only true analyte signals contribute to test results.

Derived blobs can be understood as a calculated measure that represents the effective number of analyte blobs in an image, based on total fluorescent intensity. In some embodiments, derived blobs can mean an estimated number of targets detected in an image based on the total image intensity. Specifically, derived blobs are the total intensity of all blobs in an image divided by the expected average blob intensity for the measurement. Derived blobs can be particularly useful in the high signal case where there are so many targets detected that individual blobs merge together and the blob count is not an accurate representation of the number of targets.

E. coli is the abbreviation for Escherichia coli. E. coli can be described as a Gram-negative bacterium that is commonly found in the intestinal tract of humans and animals, where many strains exist as harmless commensals. Certain strains may act as pathogenic organisms, causing infections such as urinary tract infections, bloodstream infections, or gastrointestinal disease. In the context of antimicrobial susceptibility testing, E. coli is typically regarded as one of the most prevalent uropathogens, and its growth and response to antibiotics can be used to help determine appropriate treatment options.

FISH is the abbreviation for Fluorescence In-Situ Hybridization. FISH can be understood as a molecular detection technique in which fluorescently labeled nucleic acid probes hybridize to complementary sequences within intact cells. In the context of microbial diagnostics, FISH probes may target ribosomal RNA, allowing for rapid and species-specific labeling of bacteria. The resulting fluorescence can be imaged and quantified to help identify the presence of particular organisms, and when combined with other assay components, may support both identification and susceptibility testing.

ID is the abbreviation for identification.

Measurement, as referred to herein, can be a number resulting from analyzing the signal in an imaging well of the MultiPath cartridge. Measurement can be described as the process of obtaining a quantitative signal from a specimen or reaction well that reflects the presence, amount, or behavior of analytes of interest. In the context of the described system, a measurement may involve capturing fluorescence images, processing pixel intensities, or calculating ratios such as relative growth. These measurements can provide the basis for determining whether bacterial growth has occurred, whether antibiotic effects are observed, or whether an organism has been identified at a clinically relevant concentration.

Minimum Inhibitory Concentration (MIC) can be described as the lowest concentration of an antibiotic that prevents visible growth of a bacterial population under standardized test conditions. In the context of susceptibility testing, MIC values may be compared to established clinical breakpoints to categorize a pathogen as susceptible, intermediate, or resistant to a particular antibiotic. In at least some embodiments, alternative interpretive categories may be present, such as “susceptible, increased exposure,” “susceptible, dose dependent,” or other categories. Different standards organizations, such as CLSI, STIC, or EUCAST, may define or use these interpretive categories differently and the categorization logic described herein can be adapted to accommodate such variations. Although the MultiPath AST-Direct system is capable of determining MIC values, the MultiPath AST-Direct system may report categorical results rather than full MIC values using a few antibiotic concentrations that are selected relative to published MIC breakpoints so that susceptibility categories can be accurately determined.

A MultiPath Analyzer can be considered a benchtop instrument designed to automatically process MultiPath cartridges for microbial identification and antimicrobial susceptibility testing. The analyzer may include modules for fluidics, incubation, magnetics, imaging, data analysis, and report generation, allowing each step of the assay workflow to occur without user intervention after cartridge loading. By capturing and analyzing fluorescent signals from labeled cells within cartridge wells, the analyzer can generate results that indicate the presence of specific pathogens and their susceptibility to antibiotics. The system may also archive images, perform validity checks, and interface with laboratory information systems to support clinical reporting.

A MultiPath cartridge can be described as a single-use test device that contains dried reagents, growth media, antibiotics, and imaging components arranged in wells for automated processing on the MultiPath Analyzer. The cartridge may be designed for either identification (ID) or antimicrobial susceptibility testing (AST) and can incorporate features, such as specimen distribution wells, reagent wells, and imaging wells with a dye-cushion. When loaded with a processed specimen, the cartridge can enable cell labeling, magnetic selection, and fluorescence-based imaging, thereby supporting rapid detection of target organisms and their response to antibiotics.

Pixel Intensity Units (PIU), as referred to herein, can be values that provide a measure of the light intensity detected at each pixel in an image. The value of the pixel intensity can be influenced by image acquisition parameters such as frame exposure time. PIUs may be generated by the camera sensor of the MultiPath Analyzer and can vary according to exposure time, fluorophore emission, and background correction. These units can be used to set analysis thresholds, calculate blob intensity, and normalize measurements so that detected signals correspond to expected characteristics of labeled cells.

Pixel Threshold, as referred to herein, can be the image analysis threshold that is used to separate targets from background. Any pixel that has an intensity greater than the Pixel Threshold can be part of a blob. In some embodiments, a Pixel Threshold can be described as a predefined cutoff value in pixel intensity units (PIUs) that helps distinguish meaningful fluorescence signal from background noise in an image. Pixels with intensities above the threshold may be grouped into blobs for further analysis, while those below the threshold are typically disregarded. The pixel threshold can be tuned for each test type to optimize sensitivity and specificity, ensuring that valid analyte signals are retained while minimizing interference from background variation.

Region of Interest (ROI), as referred to herein, can be the area of an image that is used for image analysis. In some embodiments, an ROI can be considered a defined portion of a captured image that corresponds to the physical boundaries of a specific well in the cartridge. ROI detection may involve locating the well edge and correcting for variations in image placement that arise from mechanical tolerances or alignment differences. By restricting image analysis to the ROI, the system can focus on relevant signal areas, reduce background noise, and improve consistency across multiple wells and cartridges.

SIR is the abbreviation for Susceptible, Intermediate or Resistant. These terms can be considered categorical interpretations of antimicrobial susceptibility results that describe how a bacterial isolate is expected to respond to a given antibiotic. A result of Susceptible(S) may indicate that the pathogen is likely to be inhibited by standard dosing of the antibiotic. A result of Intermediate (I) may suggest that the antibiotic could be effective under certain conditions, such as higher dosage or when concentrated at the site of infection. A result of Resistant (R) may imply that the pathogen is not expected to be inhibited by achievable concentrations of the antibiotic, and alternative therapies should be considered. In the MultiPath AST-Direct system, SIR outcomes can be derived from relative growth measurements at defined antibiotic concentrations selected relative to established breakpoints.

A true blob can be described as a blob in an image that corresponds to a detected target. In some embodiments, a true blob can be described as a fluorescent object within an image that remains after debris rules have been applied to exclude artifacts such as irregularly shaped or low-intensity signals. True blobs may represent valid analyte signals consistent with the expected appearance of labeled cells or particles. These objects can provide the primary count data for downstream calculations, including growth assessment and susceptibility determination. True blobs may typically be used for calculations at low to moderate analyte concentrations. At higher analyte concentrations, where true blob counts become inaccurate due to merging, derived blobs (determined from total intensity) can be used for calculations. In various embodiments, true blobs and derived blob counts may not be mixed within a single calculation, equation, or formula.

UTI is the abbreviation for Urinary Tract Infection. A UTI can be considered an infection that occurs in any part of the urinary system, which may include the urethra, bladder, ureters, or kidneys. UTIs are often caused by bacteria, with E. coli being one of the most prevalent pathogens, other organisms such as Klebsiella pneumoniae, Proteus mirabilis, Pseudomonas aeruginosa, Enterococcus faecalis, and other bacterial species may also be involved. Fungi may also cause UTIs. Although E. coli is repeatedly used throughout the disclosure, it should be understood that E. coli is used as an example bacteria, uropathogen, or other organism that can be tested for according to various embodiments of the present disclosure. Clinically, UTIs may present with symptoms such as pain during urination, increased frequency of urination, or flank pain in more severe cases. In the context of diagnostic testing, rapid identification and antimicrobial susceptibility testing of UTI-causing pathogens can be important for guiding effective therapy, mitigating symptoms, and reducing complications.

A well can be described as a discrete chamber or compartment within a MultiPath cartridge that may contain dried reagents, growth media, antibiotics, or imaging components, depending on its function. Wells can include specimen distribution wells, reagent wells, growth wells, and imaging wells, each playing a role in preparing, labeling, incubating, or detecting microorganisms. By isolating reactions in individual wells, the cartridge can support parallel testing of multiple antibiotics, concentrations, and controls, while maintaining conditions suitable for accurate imaging and analysis. A well can also be a discrete chamber of a microwell plate that can be processed by an alternative automated system, such as a liquid handling robot (e.g., available from companies such as TECAN and Hamilton), in conjunction with a plate-based imaging system.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated, and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Throughout the description and claims of this specification, the word “comprise” and variations of the word, such as “comprising” and “comprises,” means “including but not limited to,” and is not intended to exclude, for example, other additives, components, integers, or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It may be understood that this language may in some cases mean that a system (e.g., a computer) owned and/or controlled by the given entity is actually performing the action.

In some embodiments, growth measures can be used at several antibiotic concentrations. In some aspects, growth measures can include, but are not limited to, fold growth/number of doublings at two timepoints (which could be using initial value (time 0) as a reference, another time reference, or growth measured at multiple timepoints); relative growth, which compares the bacteria count estimate of an antibiotic well compared to a non-antibiotic well; and/or a combination of growth measures. In some embodiments, growth can be adjusted to account for practical assay considerations, such as nonlinear assay measurement at very high levels of cells.

In some embodiments, growth function values can be converted into antimicrobial susceptibility test (AST) parameters. MIC determination may be performed by analyzing results across several antibiotic concentrations. Analysis techniques may include, but are not limited to, applying a threshold growth function to classify the outcome at each antibiotic concentration as growth or no-growth. The MIC can be considered the lowest concentration at which no growth is detected. In certain approaches, differences between each concentration and the next lower concentration may be calculated, with the MIC corresponding to the concentration showing the largest difference. Algorithmic details may include an initial clipping of the growth function to a maximum growth level and the use of no-antibiotic or zero-concentration wells as off-scale or reference endpoints. Curve fitting may also be applied. Growth functions may also be combined with other information derived from images (e.g., cell morphology such as filaments, filament length, blob intensity, etc.) to generate rapid and accurate AST results.

In some embodiments, categorical interpretation (SIR) can be derived from antibiotic wells selected according to antibiotic breakpoints (e.g., according to Clinical and Laboratories Standards Institute (CLSI), the Food and Drug Administration's (FDAs) Antibacterial Susceptibility Test Interpretive Criteria (STIC), or European Committee on AST (EUCAST) breakpoints). The lower concentration may correspond to the susceptible(S) breakpoint, and the higher concentration may be set at one two-fold dilution below the resistant (R) breakpoint. Threshold growth functions can then be applied to classify each well as growth or no-growth. A result may be considered Susceptible(S) if neither well shows growth, Resistant (R) if both wells show growth, Intermediate (I) if only the low-concentration well shows growth, and invalid if only the high-concentration well shows growth. In some embodiments, MIC values may also be converted to categorical SIR results using standardized rules. In at least some embodiments, alternative interpretive categories may be present, such as “susceptible, increased exposure.” “susceptible, dose dependent.” or other categories. Different standards organizations, such as CLSI, STIC, or EUCAST, may define or use these interpretive categories differently and the categorization logic described herein can be adapted to accommodate such variations.

In some embodiments, performance evaluation can use several measures across the datasets to determine the best methods and the thresholds to use for those methods. The methods include, but are not limited to, well by well growth/no-growth accuracy vs. expected growth based on the reference MIC: MIC error from the growth function MIC compared to the reference MIC; and/or categorical agreement from the two breakpoint wells vs categories associated with the reference MIC.

Various embodiments of the present disclosure are directed to a UTI test and analyzing the results thereof. In at least some embodiments, the system can include a test cartridge that accepts a urine specimen from a patient suspected of having a UTI caused by a uropathogen, such as E. coli. In some embodiments, the AST test cartridge can be processed after a uropathogen has been detected at clinically relevant levels, the species identified, and the concentration estimated. The ability to identify the species present in the specimen ensures that the correct AST cartridge or test parameters are selected. Because antimicrobial susceptibility testing often relies on species-specific breakpoints and antibiotic panels, the accuracy of species identification directly impacts the validity of the downstream susceptibility result. Species identification also provides several operational and clinical benefits. From an operational perspective, species ID enables the analyzer to route the specimen to the correct set of antibiotic wells, reducing wasted reagents and ensuring consistency with laboratory workflows. Measurement of the bacterial concentration during the ID test allows the appropriate amount of specimen to be used as the inoculum for the subsequent AST test (e.g., by appropriate specimen dilution) to avoid invalid AST results. From a clinical perspective, species ID supports the generation of results that are aligned with therapeutic guidelines, since susceptibility interpretations can vary widely depending on the organism tested. Accurate species ID therefore improves both the reliability and the clinical relevance of the antibiotic effectiveness analysis.

In some embodiments, the system can operate in a species-agnostic mode, where initial susceptibility testing is performed without regard to the identified organism. This mode can be particularly useful for early rule-out testing or for settings in which species identification is delayed. In such embodiments, the output can indicate preliminary susceptibility results that are not species-specific, with the option to update the interpretation once species identification becomes available. By supporting both species-specific and species-agnostic workflows, the disclosed system provides flexibility for diverse laboratory and clinical use cases.

In some embodiments, the same urine specimen may be used to determine whether the uropathogen is detected at clinically relevant levels as any further analysis to determine susceptibility of the uropathogen to antibiotics utilized to treat UTI infections caused by those uropathogens. Specifically, various embodiments of the present disclosure determine whether the uropathogenic bacteria are susceptible, intermediate, or resistant to one or more antibiotics.

In at least some embodiments, the selected antibiotics and their concentrations for UTI caused by E. coli might be, for example, Trimethoprim-Sulfamethoxazole: 1/19 and 2/38 μg/mL, Cefazolin: 8 and 16 μg/mL, Ciprofloxacin: 0.25 and 0.5 μg/mL, Fosfomycin: 64 and 128 μg/mL, Levofloxacin: 0.5 and 1 μg/mL, Nitrofurantoin: 32 and 64 μg/mL and Amoxicillin-Clavulanate: 8/4 and 16/8 μg/mL. Susceptibility can be determined by measuring bacteria growth after several hours in the presence of growth media and each antibiotic relative to a no-growth reference (fold growth) or relative to a no-antibiotic growth reference (relative growth). Both reference measurements may be included on the cartridge.

The cartridge can come with all required reagents on board, including the means to separate bacterial cells from potential interfering substances in the urine specimen (in particular boric acid preservative and antibiotics, both of which would hinder subsequent growth), growth media, antibiotics, reagents to permeabilize and specifically label E. coli cells (or other uropathogens) using fluorescent in-situ hybridization (FISH) technology, paramagnetic particles to magnetically select labeled cells, dye-cushion to prevent detection of unbound fluorescent probe, and internal no-growth and no-antibiotic reference measurements. Once a urine specimen (or processed urine specimen) is added to the cartridge, the cartridge can be loaded onto the MultiPath analyzer for processing with no further required steps to be performed by a human. Urine specimen processing can include size exclusion chromatography, centrifugation with washing, filtration, various cell capture methods, and/or colony isolation, along with various other processing methods. Various embodiments of the present disclosure can process UTI AST test cartridges on the MultiPath analyzer (as an example), which is a computing device configured to receive and/or generate images of specific bacteria within specimens, identify features of the images, and determine susceptibility based on the features of the images.

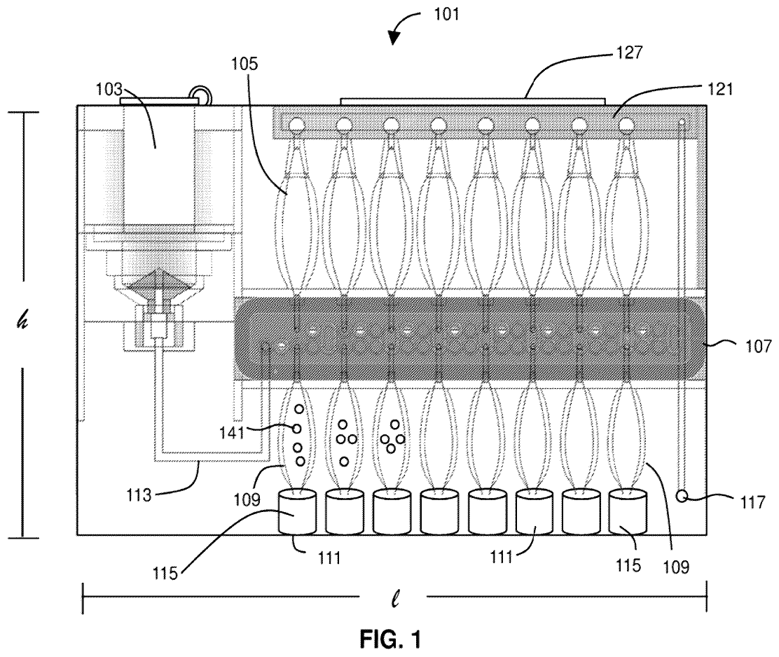

Although the focus of the present disclosure is to the process performed by the MultiPath analyzer, it may be important to understand the structural elements of at least one embodiment of the cartridge and well layout thereof. One side of an example test cartridge is shown schematically in FIG. 1 (FIG. 1). The test comprises a two-sided cartridge utilizing eight channels on side A and eight channels on side B: all sixteen channels contain dried growth media in the distribution wells. Various embodiments of test cartridges can have fewer or greater amounts of wells or channels in a test cartridge. In one example, side A contains the no-growth reference measurement (also with no antibiotic), the no-antibiotic growth reference measurement and various antibiotics at two concentrations each. In one example, side B contains four additional antibiotics, each at two concentrations.

FIG. 1 shows an interior view of the cartridge that highlights the specimen well, the reaction channels, and the valve. In at least some embodiments, the cartridge may comprise channels with an upper division well, a middle reagent well, and a lower reaction/imaging well. FIG. 1 shows a cartridge 101 used in various systems and methods of the invention. The testing cartridge 101 includes a specimen well 103 for receiving a specimen, division wells 105, reagent wells 109, imaging wells 111, and connecting fluid/air paths 113 for moving the specimen between the wells, as well as a sliding valve 107 for controlling fluid movement. The cartridge 101 may include reagents for specific assays. For example, in the reagent wells 109, the cartridge may include a target-specific probe, permeabilization reagents, paramagnetic cell-binding particles, fluidic control particles, or other materials, and those may be provided as beads 141 (e.g., lyophilized beads).

As shown, the cartridge may include a plurality of paired imaging well/incubation well sets in parallel to one another. Here, the cartridge 101 is shown as including 8 parallel “channels” in which each channel includes a division well 105, a reagent well 109, and an imaging well 111. At least one embodiments of the cartridge may include 2 gangs of 8 channels (the additional 8 channels would be behind the eight visible channels as only one side of the cartridge is shown in FIG. 1) for 16 channels in one cartridge. The cartridge may be described according to its dimensions such as height h, length l, and width w (where w is measured orthogonal to h & l). In some embodiments, the height h may be between about 3 and 10 cm. In some embodiments, the length l may be between about 5 and 12 cm. In some embodiments, the width w may be between about 0.5 and 3 cm. For example, in one embodiment, h is about 6 cm, 1 is about 8 cm, and w is about 2 cm.

The cartridge 101 preferably includes a specimen well 103 into which a user can pipette the specimen or processed specimen into the cartridge. The biological specimen can undergo one or more processing steps to ensure that the sample is suitable for analysis. In the case of a urine specimen, these steps can include verifying that the specimen meets pre-defined acceptance criteria, such as the presence of sufficient cellular material or an absence of obvious contamination. In some embodiments, the analyzer can implement automated checks to confirm sample volume, clarity, or turbidity prior to initiating imaging. If the specimen fails these checks, it can be flagged as invalid and the system can prompt for a repeat collection.

In some embodiments, the specimen can be subjected to dilution or buffer exchange to normalize the chemical composition of the sample. For example, urine specimens can have variable salt concentrations, which may interfere with bacterial growth or with fluorescent labeling efficiency. By diluting the specimen with a standardized buffer, the system can reduce variability between patients and ensure that the assay operates within an optimized physiological range. Sample processing can also involve adjusting the pathogen concentration to fall within a target range. If the input specimen contains too few bacteria, the system may not detect sufficient signal during incubation; conversely, if the input specimen is too concentrated, rapid overgrowth can obscure antibiotic effects. Accordingly, the specimen can be diluted or concentrated to achieve a target pathogen concentration, which can be confirmed by preliminary imaging or by optical density measurements to avoid inaccurate or invalid AST results.

In certain embodiments, the cartridge 101 includes a sliding valve 107 comprising a gasket with channels therethrough. When the sliding valve 107 is positioned at a first position, the specimen well 103 is in fluid communication with division wells 105 to enable specimen distribution while the reagent wells 109 and imaging wells 111 are sealed off. In various embodiments, when the sliding valve 107 is in a second position, the first division well 105 and its corresponding reagent well 109 and imaging well 111 are in fluid communication with one another. In some embodiments the remaining 15 division wells are sealed off from each other and their respective reagent and imaging wells. In some embodiments, when the sliding valve 107 is in a third position, the remaining division wells 105 and their corresponding reagent wells 109 and imaging wells 111 are in fluid communication with each other.

The cartridge 101 may include a fitting 117 for coupling to an external instrument to receive pneumatic (positive or negative) pressure there from to divide (hence. “division”) the specimen from the specimen well 103 into the division wells 105 and to subsequently pass liquid from the division wells 105 into corresponding reagent wells 109 and imaging wells 111. The imaging wells 111 preferably include a dye-cushion 115 dried onto the bottom of a transparent window (e.g., on the bottom of the cartridge 101).

The dye-cushion 115 is a material dried onto the bottom of the imaging wells 111. Once a portion of a reaction is transferred into an imaging well 111, the dye-cushion can solubilize to form a dense liquid dye-cushion layer 115 that underlies a less dense liquid reaction layer. The dye-cushion is preferably a material that resists migration of particles (e.g., a density medium, a gel, or the like) and inhibits passage of light (e.g., through the inclusion of a pigment or dye). Due to the dye-cushion 115, probes are only pulled to a detection zone (i.e., close to the surface of the optically clear well bottom and an optical depth of field) when bound to a target that is also bound to a magnetic particle. The dye-cushion 115 excludes unbound material from the window that provides a detection zone (because it sits as a cushion layer underlying the liquid specimen layer) and it inhibits light from unbound signaling moieties from reaching the detection zone (because the dye-cushion layer includes dye and is not transparent).

The cartridge 101 can interface with a fluidics module of an instrument via a pneumatic port 117 that supplies positive or negative air pressure to the cartridge The sliding valve 107 can control the movement of fluid between the sample well 103 and the division wells 105, or between the division wells 105 and the reagent wells 109 and imaging wells 111 by opening and closing connections. The sliding valve 107 (or one or more sliding valves) may connect only the first division well 105 to its corresponding reagent 109 and imaging 111 wells to provide a zero-growth reference for AST analysis while the remaining 15 division wells remain fluidically isolated from one another to allow independent growth to occur. The sliding valves 107 (one on each side of the cartridge) may be pushed in synchrony by the fluidics module of an instrument. The distribution wells 105 can be pre-filled with growth media and/or one or more antimicrobial agents. In a preferred embodiment, the growth media is dried onto the surface of the distribution wells 105 while the antimicrobial agents are added as lyophilized beads (they can also be dried onto the surface). Typically, the two concentrations of each antimicrobial agent are achieved by the placement of either one bead (lower antibiotic concentration) or two beads (higher antibiotic concentration) into the wells 105. The valves 107 can hold the specimen portions (i.e., the growth reactions) in the distribution wells 105 to be incubated in the presence of the various antimicrobial agents (or without an antimicrobial agent as a key reference reaction) to allow for bacterial growth for any period of time.

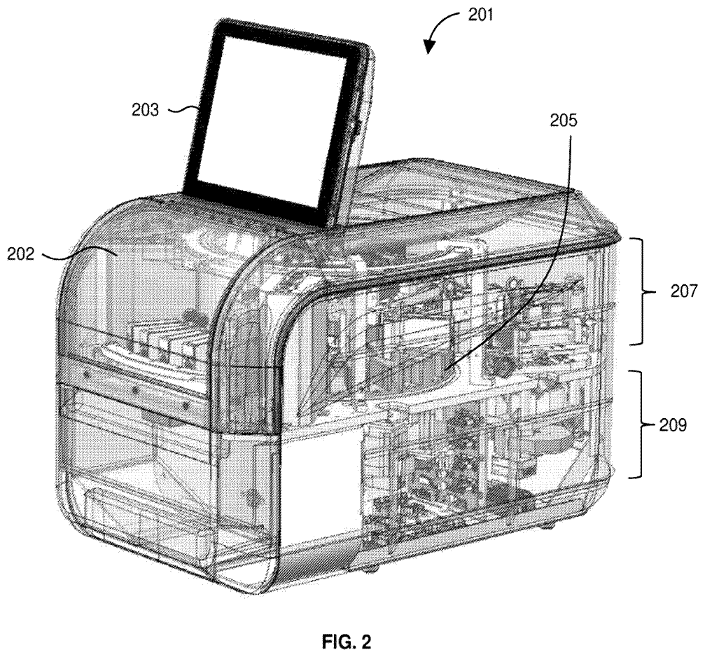

FIG. 2 shows an instrument 201 (e.g., analyzer) for performing microbe identification and antibiotic susceptibility testing (AST) using a cartridge 101. The instrument 201 may be used to interact with cartridges 101 to carry out target cell identification/quantitation and AST analysis of specimens. A lift-to-open loading door 202 may be included to provide access to a loading tray.

The instrument 201 includes at least one user interface 203 (e.g., a touch screen) to display prompts, results, reports and to receive commands. The instrument 201 can comprise different functional areas and subsystems. The compartments may include a carousel 205 for transporting cartridges to various sub-modules (e.g., fluidics, magnetics, imaging) and incubating cartridges, an upper compartment 207 housing processing and incubation equipment, and a lower compartment 209 housing electronics, imaging, and pneumatic equipment. The instrument may also control the temperature in the various sub-modules for optimal assay step performance. The instrument 201 and methods of the disclosure may be used to identify and quantify a variety of target cells or microbes including viruses, bacteria, fungi, parasites, human cells, animal cells, plant cells. By tailoring the growth media, the antimicrobial agents, the permeabilization reagents, and the target-specific probe(s) to the target cell or microbe, AST analysis can be performed on a variety of target microbes.

In some embodiments, the reagents for fluorescent labeling can implement a fluorescence in situ hybridization (FISH) process that is configured for compatibility with cartridge-based automation. In some embodiments, unlabeled “helper” probes can be hybridized adjacent to the labeled probe, typically flanking the target region. These helper probes can reduce local secondary structure, thereby improving access and hybridization efficiency of the labeled probe to its ribosomal RNA target. In some embodiments, the FISH reaction can be performed as an all-in-one, single-step, single-temperature process that concurrently performs permeabilization and hybridization without separate fixation or washing steps. This streamlined approach minimizes reagent transfers and mechanical complexity within the cartridge and allows rapid completion (e.g., within approximately 30 minutes) while maintaining high signal intensity and specificity. The aforementioned single-step hybridization approach offers advantages in automation, reproducibility, and instrument simplicity. However, other multi-step or multi-temperature hybridization methods may also be employed within the scope of the disclosure.

In at least one embodiment, an example cartridge layout of the growth wells (with A-side and B-side) is defined as described below in Table 1 (growth media-present in the example 16 distribution wells—is not shown). Please note that Table uses identifiers like A01, A02, A03, etc. to describe channels or wells within the cartridge. The number of channels/wells within the cartridge may be greater or fewer than the sixteen described. The specific antibiotics chosen for each channel/well provide merely an example.

TABLE 1
Example Division Well Layout of Example AST Test cartridge

| | | Incubation | |
|---|---|---|---|
| Well | Name | at 35° C. | Description |
| A01 | t0 | N | No incubation (or t0) reference measurement |
| A02 | No Abx | Y | Growth with no antibiotic reference measurement |
| A03 | Abx 1L | Y | Trimethoprim-Sulfamethoxazole at a low concentration |
| | | | (e.g., 1/19 μg/mL) |
| A04 | Abx 1H | Y | Trimethoprim-Sulfamethoxazole at a high concentration |
| | | | (e.g., 2/38 μg/mL) |
| A05 | Abx 2L | Y | Cefazolin at a low concentration (e.g., 8 μg/mL) |
| A06 | Abx 2H | Y | Cefazolin at a high concentration (e.g., 16 μg/mL) |
| A07 | Abx 3L | Y | Ciprofloxacin at a low concentration (e.g., 0.25 μg/mL) |
| A08 | Abx 3H | Y | Ciprofloxacin at a high concentration (e.g., 0.5 μg/mL) |
| B01 | Abx 4L | Y | Fosfomycin at a low concentration (e.g., 64 μg/mL) |
| B02 | Abx 4H | Y | Fosfomycin at a high concentration (e.g., 128 μg/mL) |
| B03 | Abx 5L | Y | Levofloxacin at a low concentration (e.g., 0.5 μg/mL) |
| B04 | Abx 5H | Y | Levofloxacin at a high concentration (e.g., 1 μg/mL) |
| B05 | Abx 6L | Y | Nitrofurantoin at a low concentration (e.g., 32 μg/mL) |
| B06 | Abx 6H | Y | Nitrofurantoin at a high concentration (e.g., 64 μg/mL) |
| B07 | Abx 7L | Y | Amoxicillin-Clavulanate at a low concentration (e.g., |
| | | | 8/4 μg/mL) |
| B08 | Abx 7H | Y | Amoxicillin-Clavulanate at a high concentration (e.g., |
| | | | 16/8 μg/mL) |

Handling of the example cartridge utilizes workflow steps and timing defined below in Table 2. Table 2 defines the sequence of processing steps for the example test cartridge. Table 2 also defines at least one example of a minimum processing time for each step along with at least one example of an expected processing time for each step. The scheduler can wait the minimum time before moving the cartridge to the next station. Note that because of the no-incubation (or t0) reference measurement, each test cartridge can be processed twice on the fluidics module, twice on the magnetics module and twice on the imaging module, with two different incubation times on the main carousel (for example, incubation for cell labeling for TO in the first reaction well occurs concomitantly with incubation for growth in the remaining 15 growth wells). Cartridge processing can use a cycle-based scheduling algorithm. With this approach the core processing operations start and stop on fixed points in a cycle and the expected processing time is based on an integer number of cycles. Each cycle can be a set period of time. For example, a cycle can be seventy-five seconds. See Table 3 for Cycle Processing Times later in this section for the expected wait time. To ensure that each test cartridge is processed consistently, the minimum wait time must be set to another set period of time (e.g., twenty seconds) before or after the closest cycle boundary.

TABLE 2
Example Workflow and Processing Times for UTI Test

| | | | Minimum | | Expected |
|---|---|---|---|---|---|
| | | | time | Number | time |
| Step | Processing step | Location | (min:sec) | of cycles | (min:sec) |
| 1 | Cartridge loading | Rack area | 0 | 0 | User load |
| | | | | | time, system |
| | | | | | queuing |
| 2 | Wait for fluidics | Carousel | 0 | 0 | ASAP, based |
| | | | | | on system |
| | | | | | backlog |
| 3 | Time 0 Fluidic | Fluidics station | 4:00 | 4 | 4:39 |
| | activation processing | | | | |
| 4 | Time 0 | Carousel | 30:15 | 24 | 30:46 |
| | Measurement | | | | |
| | reaction time (no- | | | | |
| | growth reference) | | | | |
| 5 | Time 0 Magnetics | Magnetics | 4:00 | 4 | 4:39 |
| | | station | | | |
| 6 | Time 0 Transfer to | Carousel | 0 | 0 | 0:46 |
| | imaging | | | | |
| 7 | Time 0 Imaging | Imaging station | 1:45 | 2 | 2:09 |
| 8 | Growth time | Carousel | 200:15 | 160 | 200:46 |
| 9 | Time 1 Fluidic | Fluidics station | 1:45 | 2 | 2:09 |
| | activation processing | | | | |
| 10 | Time 1 labeling | Carousel | 30:15 | 24 | 30:46 |
| | reaction time | | | | |
| | (growth | | | | |
| | measurement) | | | | |
| 11 | Time 1 Magnetics | Magnetics | 4:00 | 4 | 4:39 |
| | | station | | | |
| 12 | Time 1 Transfer to | Carousel | 0 | 0 | 0:46 |
| | imaging | | | | |
| 13 | Time 1 Imaging | Imaging station | 4:00 | 4 | 4:39 |
| 14 | Ready for trash | Carousel | 0 | 0 | ASAP, based |
| | | | | | on trash bin |
| | | | | | capacity and |
| | | | | | system |
| | | | | | queuing |

TABLE 3
Example Cycle Processing Times (1 cycle is 75 seconds)
Subsystem Time in min:sec

| Number of | | | | Imaging | |
|---|---|---|---|---|---|
| cycles | Fluidics | Reaction | Magnets | Transfer | Imager |
| 0 | N/A | 0:46 | N/A | 0:46 | N/A |
| 1 | 0:54 | 2:01 | 0:54 | 2:01 | 0:54 |
| 2 | 2:09 | 3:16 | 2:09 | 3:16 | 2:09 |
| 3 | 3:24 | 4:31 | 3:24 | 4:31 | 3:24 |
| 4 | 4:39 | 5:46 | 4:39 | 5:46 | 4:39 |
| 5 | 5:54 | 7:01 | 5:54 | 7:01 | 5:54 |
| 6 | 7:09 | 8:16 | 7:09 | 8:16 | 7:09 |
| 7 | 8:24 | 9:31 | 8:24 | 9:31 | 8:24 |
| 8 | 9:39 | 10:46 | 9:39 | 10:46 | 9:39 |
| 9 | 10:54 | 12:01 | 10:54 | 12:01 | 10:54 |
| 10 | 12:09 | 13:16 | 12:09 | 13:16 | 12:09 |
| 11 | 13:24 | 14:31 | 13:24 | 14:31 | 13:24 |
| 12 | 14:39 | 15:46 | 14:39 | 15:46 | 14:39 |
| 13 | 15:54 | 17:01 | 15:54 | 17:01 | 15:54 |
| 14 | 17:09 | 18:16 | 17:09 | 18:16 | 17:09 |
| 15 | 18:24 | 19:31 | 18:24 | 19:31 | 18:24 |
| 16 | 19:39 | 20:46 | 19:39 | 20:46 | 19:39 |
| 17 | 20:54 | 22:01 | 20:54 | 22:01 | 20:54 |
| 18 | 22:09 | 23:16 | 22:09 | 23:16 | 22:09 |
| 19 | 23:24 | 24:31 | 23:24 | 24:31 | 23:24 |
| 20 | 24:39 | 25:46 | 24:39 | 25:46 | 24:39 |
| 21 | 25:54 | 27:01 | 25:54 | 27:01 | 25:54 |
| 22 | 27:09 | 28:16 | 27:09 | 28:16 | 27:09 |
| 23 | 28:24 | 29:31 | 28:24 | 29:31 | 28:24 |
| 24 | 29:39 | 30:46 | 29:39 | 30:46 | 29:39 |
| 25 | 30:54 | 32:01 | 30:54 | 32:01 | 30:54 |
| 26 | 32:09 | 33:16 | 32:09 | 33:16 | 32:09 |
| 27 | 33:24 | 34:31 | 33:24 | 34:31 | 33:24 |
| 28 | 34:39 | 35:46 | 34:39 | 35:46 | 34:39 |
| 29 | 35:54 | 37:01 | 35:54 | 37:01 | 35:54 |
| 30 | 37:09 | 38:16 | 37:09 | 38:16 | 37:09 |
| 31 | 38:24 | 39:31 | 38:24 | 39:31 | 38:24 |
| 32 | 39:39 | 40:46 | 39:39 | 40:46 | 39:39 |
| 33 | 40:54 | 42:01 | 40:54 | 42:01 | 40:54 |
| 34 | 42:09 | 43:16 | 42:09 | 43:16 | 42:09 |
| 35 | 43:24 | 44:31 | 43:24 | 44:31 | 43:24 |
| 36 | 44:39 | 45:46 | 44:39 | 45:46 | 44:39 |
| 37 | 45:54 | 47:01 | 45:54 | 47:01 | 45:54 |
| 38 | 47:09 | 48:16 | 47:09 | 48:16 | 47:09 |
| 39 | 48:24 | 49:31 | 48:24 | 49:31 | 48:24 |
| 40 | 49:39 | 50:46 | 49:39 | 50:46 | 49:39 |
| 41 | 50:54 | 52:01 | 50:54 | 52:01 | 50:54 |
| 42 | 52:09 | 53:16 | 52:09 | 53:16 | 52:09 |
| 43 | 53:24 | 54:31 | 53:24 | 54:31 | 53:24 |

Fluidics activation for the UTI test occurs twice at two distinct times (steps 3 and 9 in Table 2 above). The first fluidics activation is called “Time 0 Fluidics” and the second fluidics is called “Time 1 Fluidics”. The steps involved for each are described and detailed below.

To facilitate ease of understanding and review, the fluidic processing steps are described at a functional level and are later implemented in the test definition as a detailed set of fluidic instructions. In general, all port numbers are assumed to be set to zero unless otherwise specified. Each parameter for a given instruction is considered unchanged from the prior instruction unless specifically modified. Parameters that are not specified in the first instruction are considered to begin at default values. When operations such as “push,” “pull,” or “volume move” are indicated, the channel mode can be set to “PUMP” within the fluidic instructions. If a loop is specified, the implementation may repeat the designated sequence of instructions. For reference, “Valve Position” corresponds to the “camPosition” parameter in the instructions, and “Duration” corresponds to the “timeMillis” parameter.

The valves can be moved to a first position (e.g., 2 mm) and the processed specimen is then pulled from the reservoir into each of the sixteen distribution wells using negative pressure applied through the manifold, while air is displaced through membranes at the tops of the wells. The valves are then moved to a second position (e.g., 4 mm) to open a fluid path specifically between distribution well A01 and its paired reagent and imaging wells. Positive pressure is applied to push the contents of A01 through the reagent well, thereby hydrating the lyophilized reagent beads, and into the A01 imaging well, thereby hydrating the dried dye-cushion, with displaced air vented through the membrane at the top of the imaging well.

During Time 0 (T0) fluidics processing, the cartridge heater plates can be maintained at a set temperature. During the Time 1 (T1) fluidics sequence and after the growth incubation is step is completed, the valves can be repositioned to the third position (e.g., 6 mm) to open fluid paths between each of the remaining distribution wells (all wells except A01, for example) and their corresponding reagent and imaging wells. Once the fluid paths are opened, positive pressure can be applied to move the liquid contents of the distribution wells through the reagent wells. As the liquid passes through, the lyophilized reagent beads contained in the reagent wells can be hydrated. The liquid then continues into the imaging wells, resolubilizing the dried dye-cushion and displacing air through the vent membranes located at the tops of the imaging wells. This coordinated transfer ensures that reagents are properly mixed with the growth reactions and delivered into the imaging wells, where subsequent incubation, labeling, and imaging steps can occur. During Time 1 fluidics processing, the cartridge heater plates are maintained set temperature. Liquid transfer to the imaging wells is carried out with a push vacuum. These parameters ensure consistent hydration of lyophilized reagents and proper delivery of the growth reactions into the imaging wells for subsequent incubation and imaging. Once the cartridge is prepared, specimen images can be acquired and sent to the computing device for image analysis, results computations, and report generation.

In various embodiments of the present disclosure, at least one feature is the use of direct imaging of fluorescent objects within the imaging wells, rather than relying solely on bulk growth measurements or indirect metabolic indicators. Imaging allows the computing device to capture not only quantitative metrics, such as the number and intensity of detected objects, but also qualitative morphological information about the organisms under test. For example, features such as cell compactness, elongation, aspect ratio, and filamentation can be extracted directly from the image data. These imaging-derived metrics provide a rich dataset for analysis as compared to growth-only systems to produce accurate AST results more quickly than other methods.

By leveraging imaging, the system can identify antibiotic effects that manifest as morphological changes even before substantial differences in overall biomass are measurable. For instance, susceptible bacteria may undergo filamentation (e.g., presence of filaments, filament length, filament density in an antibiotic and/or antibiotic concentration dependent manner) or altered morphology in the presence of an antibiotic, which can be captured as distinct shape changes in the detected blobs. Resistant bacteria, by contrast, may retain their typical morphology and continue to divide normally. Thus, imaging-based analysis provides an early and more nuanced view of antimicrobial activity that can accelerate time-to-result and increase diagnostic accuracy.

In various embodiments, the imaging data can be combined into classifiers or machine learning models that weigh both quantitative and morphological inputs to generate a susceptibility determination. This integration of morphology-based information distinguishes the disclosed system from conventional assays that assess antimicrobial activity only in terms of growth or no-growth endpoints.

In some embodiments, the machine learning model can be trained using a dataset of annotated images in which blob counts, derived intensities, morphological features, growth functions, etc. are combined and are associated with known susceptibility outcomes, such as those determined by broth microdilution (BMD) or other reference methods. The model can therefore learn to weight individual features, such as compactness, elongation, or filamentation, according to their predictive value for susceptibility determination. In some embodiments, a classifier may be implemented as a statistical model, such as logistic regression, a tree-based model such as a random forest, or a deep learning architecture such as a convolutional neural network (CNN). The choice of model can depend on computational resources, dataset size, and the complexity of features extracted from the imaging data. While the disclosed system can perform rule-based determinations of growth and susceptibility, machine learning models and classifiers provide an alternative or supplemental pathway to interpret results. In some embodiments, the output of both rule-based and machine learning approaches can be compared, and discrepancies can be flagged for retesting and review:

The UTI test can use image acquisition parameters described below. At both Time 0 and Time 1, focusing can be performed using the green color channel with two frames acquired at a set exposure time (e.g., 10 milliseconds per frame). For image capture, both green and red color channels can be used for each of the sixteen imaging wells. In various embodiments, in the green channel, two frames can be acquired per well with a set exposure time (e.g., 10 milliseconds per frame). In various embodiments, in the red channel, sixteen frames can be acquired per well with a set exposure time (e.g., 100 milliseconds per frame).

The region of interest (ROI) for each well can be detected using the green color channel. The specific ROI calculator type and associated parameters can be determined through engineering analysis of the black imaging wells. Images acquired in the green channel can be analyzed for fluorescent and magnetic focus particles. These images can undergo pre-processing with field flattening, after which a pixel threshold of a set pixel intensity units (e.g., 25 PIU) is applied. Images acquired in the red channel can be analyzed for FISH-labeled cells. In this case, hot pixels can be removed prior to analysis, pre-processing can again use field flattening, and a pixel threshold (e.g., 120 PIU) can be applied. Debris rules are then applied to classify each detected blob. A cascade debris rule combines multiple sub-rules, identifying a blob as debris if any one of the sub-rules applies. Size and shape rules are used to remove blobs that are unusually large with high intensity or that appear as non-compact, fiber-like structures with large areas. Additional debris rules apply thresholds for high signal blob fraction, high signal total intensity, fiber-like compactness and area, and large blob area. Out-of-focus debris rules are also applied to eliminate bright signals that appear outside the focal plane. Together, these parameters establish how raw images are processed into analyzable data that can be used to determine bacterial presence and growth.

In at least some embodiments, the ROI can be detected using the parameters defined below in Table 4.

TABLE 4
Example ROI Detection Parameters for UTI Test cartridge

| Parameter | All Wells |
|---|---|
| ROI color | Green (listed first in well color configuration) |
| channel | |
| ROI calculator | ROI calculator type and parameters are to be determined |
| type | based on engineering analysis of the back imaging wells |

The green channel of images can be analyzed for the fluorescent focus particles as listed below in Table 5.

TABLE 5
Image Analysis Parameters for FISH
Focus Particles (green channel)

| | Focus Particles |
|---|---|
| Parameter | (All Wells) |
| Pre-processing mode | Field Flatten |
| Pixel threshold | 25 Relative fluorescent units (PIU) |
| Blob threshold | 0 PIU (disabled) |
| Average blob intensity | 400 PIU |

The red channel can be analyzed for FISH labeled cells as listed below in Table 6.

TABLE 6
Example Image Analysis Parameters for FISH targets (red channel)

| | FISH Targets |
|---|---|
| Parameter | (All Wells) |
| Hot pixels | Removed |
| Pre-processing mode | Field Flatten |
| Pixel threshold | 120 PIU |
| Blob threshold | 0 PIU (disabled) |
| Average blob intensity | 375 PIU |

Debris rules can be used to classify each “blob.” The UTI Test can use the debris rules for analysis of the focus particles in the Green channel as defined below in Table 7.

TABLE 7
Debris Rules for Focus Particles for UTI AST-Direct E. coli Test cartridge

| Rule | Parameter | Value | Description |
|---|---|---|---|
| Cascade debris | This is the top-level rule that combines the other rules such that a blob | | |
| rule | is declared debris if any cascaded rule detects debris. | | |
| Size and shape | Removes debris based on blobs with large size with high intensity or | | |
| debris rule | non-compact blobs (i.e., fiber like) with large area | | |
| | High signal blob | 0.07 | Used to detect a high signal case which |
| | fraction | | disables the detection of debris with this |
| | | | rule. The rule is disabled if both high |
| | | | signal blob fraction and total intensity |
| | | | are above the specified thresholds. |
| | High signal total | 5,050,000 | Used to detect a high signal case which |
| | intensity | | disables the detection of debris with this |
| | | | rule. The rule is disabled if both high |
| | | | signal blob fraction and total intensity |
| | | | are above the specified thresholds. |
| | Fiber remove | 4 | Determines if a blob is fiber-like. |
| | blob | | “Compactness” is an inverse measure |
| | compactness | | that increases as the blobs perimeter to |
| | | | area ratio increases. |
| | Fiber remove | 60 | A blob is declared debris if it is fiber- |
| | blob area | | like based on the compactness threshold |
| | | | and has an area greater than this |
| | | | threshold. |
| | Large blob | 30 | Used to declare large and bright blobs as |
| | remove area | | debris. If both a blob's area is greater |
| | | | than the large blob remove area and its |
| | | | intensity is greater than large blob |
| | | | remove intensity, the blob is declared |
| | | | debris. |
| | Large blob | 7,000 | Used to declare large and bright blobs as |
| | remove intensity | | debris. If both a blob's area is greater |
| | | | than the large blob remove area and its |
| | | | intensity is greater than large blob |
| | | | remove intensity, the blob is declared |
| | | | debris. |
| Out of focus | Removes debris from an area of the image that has the image | | |
| debris rule | background raised above the typical background of the image. This | | |
| | effect can be caused by bright debris on the outside of the well that is | | |
| | out of focus on the imaging plane. | | |
| | High signal blob | 0.07 | Used to detect a high signal case which |
| | fraction | | disables the detection of debris with this |
| | | | rule. The rule is disabled if both high |
| | | | signal blob fraction and total intensity |
| | | | are above the specified thresholds. |
| | High signal total | 5,050,000 | Used to detect a high signal case which |
| | intensity | | disables the detection of debris with this |
| | | | rule. The rule is disabled if both high |
| | | | signal blob fraction and total intensity |
| | | | are above the specified thresholds. |
| | Pixel threshold | 0.5 | Detects a raised background area if all |
| | fraction | | pixels are above the pixel threshold |
| | | | multiplied by this fraction. |
| | Debris remove | 40 | If the area of the raised background is |
| | blob area | | greater than this value, all blobs that in |
| | | | this area are declared debris. |

The UTI Test can use the following debris rules for analysis of FISH labeled cells (wells A01-A08 and B01-B08) using the Red color channel, as defined below in Table 8.

TABLE 8
Debris Rules for FISH Labeled Cells for UTI AST-Direct E. coli Test cartridge

| Rule | Parameter | Value | Description |
|---|---|---|---|
| Cascade debris | This is the top-level rule that combines the other rules such that a blob | | |
| rule | is declared debris if any cascaded rule detects debris. | | |
| | It is expected that the FISH debris rules will be updated based on image | | |
| | analysis optimization performed on representative samples. | | |
| Size and shape | Removes debris based on blobs with large size with high intensity or | | |
| debris rule | non-compact blobs (i.e., fiber like) with large area | | |
| | High signal blob | 0.07 | Used to detect a high signal case which |
| | fraction | | disables the detection of debris with this |
| | | | rule. The rule is disabled if both high |
| | | | signal blob fraction and total intensity |
| | | | are above the specified thresholds. |
| | High signal total | 5,050,000 | Used to detect a high signal case which |
| | intensity | | disables the detection of debris with this |
| | | | rule. The rule is disabled if both high |
| | | | signal blob fraction and total intensity |
| | | | are above the specified thresholds. |
| | Fiber remove | 5 | Determines if a blob is fiber-like. |
| | blob | | “Compactness” is an inverse measure |
| | compactness | | that increases as the blobs perimeter to |
| | | | area ratio increases. |
| | Fiber remove | 30 | A blob is declared debris if it is fiber- |
| | blob area | | like based on the compactness threshold |
| | | | and has an area greater than this |
| | | | threshold. |
| | Large blob | 23 | Used to declare large and bright blobs as |
| | remove area | | debris. If both a blob's area is greater |
| | | | than the large blob remove area and its |
| | | | intensity is greater than large blob |
| | | | remove intensity, the blob is declared |
| | | | debris. |
| | Large blob | 8,000 | Used to declare large and bright blobs as |
| | remove intensity | | debris. If both a blob's area is greater |
| | | | than the large blob remove area and its |
| | | | intensity is greater than large blob |
| | | | remove intensity, the blob is declared |
| | | | debris. |
| Out of focus | Removes debris from an area of the image that has the image | | |
| debris rule | background raised above the typical background of the image. This | | |
| | effect can be caused by bright debris on the outside of the well that is | | |
| | out of focus on the imaging plane. | | |
| | High signal blob | 0.07 | Used to detect a high signal case which |
| | fraction | | disables the detection of debris with this |
| | | | rule. The rule is disabled if both high |
| | | | signal blob fraction and total intensity |
| | | | are above the specified thresholds. |
| | High signal total | 5,050,000 | Used to detect a high signal case which |
| | intensity | | disables the detection of debris with this |
| | | | rule. The rule is disabled if both high |
| | | | signal blob fraction and total intensity |
| | | | are above the specified thresholds. |
| | Pixel threshold | 0.7 | Detects a raised background area if all |
| | fraction | | pixels are above the pixel threshold |
| | | | multiplied by this fraction. |
| | Debris remove | 20 | If the area of the raised background is |
| | blob area | | greater than this value, all blobs that in |
| | | | this area are declared debris. |

Results analysis uses the output of image processing to compute the result for each test target and the overall result summary. In addition, the validity of each of these results is computed. For an example UTI E. coli Test, the test targets are defined in the following table (Table 9):

TABLE 9
UTI AST-Direct E. coli Test targets

| | | Low | High |
|---|---|---|---|
| | | concentration | concentration |
| Test Target Name | Antibiotic | well | well |
| E. coli:Abx1 | Abx1 | A03 (Abx1L) | A04 (Abx1H) |
| E. coli:Abx2 | Abx2 | A05 (Abx2L) | A06 (Abx2H) |
| E. coli:Abx3 | Abx3 | A07 (Abx3L) | A08 (Abx3H) |
| E. coli:Abx4 | Abx4 | B01 (Abx4L) | B02 (Abx4H) |
| E. coli:Abx5 | Abx5 | B03 (Abx5L) | B04 (Abx5H) |
| E. coli:Abx6 | Abx6 | B05 (Abx6L) | B06 (Abx6H) |
| E. coli:Abx7 | Abx7 | B07 (Abx7L) | B08 (Abx7H) |

Possible results for each test target are: Susceptible, Intermediate, Resistant, or Invalid. The approach used to determine the result for each target is to first assess bacterial growth in the two associated wells containing low and high antibiotic concentrations. Possible intermediate values are: “Growth,” “No-Growth,” and “Invalid.”

Validity determinations may pertain to the UTI Test cartridge as a whole or to an individual target. Possible causes of invalid results and the responses to them are shown below in Table.

TABLE 10
Invalidity Reasons and Responses for UTI AST-Direct E. coli Test

| Invalidity | | |
|---|---|---|
| Reason | Cause | Error Type |
| Fluidics Error | An error was detected during the | Full Cartridge Invalid |
| | fluidics operation. This is typically | |
| | due to a failed check as defined in | |
| | section Error! Reference source | |
| | not found. | |
| Imaging Error | An unrecoverable imaging | Full Cartridge Invalid |
| | acquisition error occurred | |
| Focusing Error | The focusing process could not find | 1) Full Cartridge Invalid (If error in A01 |
| | an optimal focus within the search | or A02) |
| | range | 2) Associated Abx Invalid (if error in |
| | | A03-B08) |
| Process | The actual operation time was | Full Cartridge Invalid |
| Duration Error | outside the allowable operation time | |
| | (growth time within +−2% of | |
| | expected, reaction and magnet time | |
| | within +−5% of expected) | |
| Scheduling | An internal error occurred in the | Full Cartridge Invalid |
| Error | scheduler | |
| Result | A computation error occurred | Full Cartridge Invalid |
| Computation | executing the results determination | |
| Error | script (for example a divide by zero | |
| | error not all images available) | |
| ROI Error | The imaging well was not detected in | 1) Full Cartridge Invalid (If error in A01 |
| | the image | or A02) |
| | | 2) Associated Abx Invalid (if error in |
| | | A03-B08) |
| Validity Script | One of the validity check parameters | Full Cartridge or associated antibiotic |
| Error | is outside the acceptable range | based on error logic (see section Error! |
| | | Reference source not found.) |
| Fluidics | The fluidic control blob count is | 1) Full Cartridge Invalid (If error in A01 |
| Control Error | outside the expected range. | or A02) |
| | | 2) Associated Abx Invalid (if error in |
| | | A03-B08) |
| AST Reference | The measured growth (A02 / A01) is | Full Cartridge Invalid |
| Error | below the acceptable level | |
| AST Reference | The No-growth reference (well A01) | Full Cartridge Invalid |
| Error | blob count is outside the acceptable | |
| | range | |
| Relative | Relative growth exceeds expected | Associated Abx Invalid |
| growth out of | maximum threshold for relative | |
| range | growth | |

In at least some embodiments, the UTI test results determination logic can consider derived blobs or true blobs to make the determination. For example, for results and validity analysis using FISH detection in the Red color channel, derived blobs can be used unless their level is less than a “use derived threshold,” in which case true blobs are used. When a ratio or blob comparison is made, derived blobs can be used for both values, unless both are less than the “use derived threshold,” in which case true blobs are used for both values. True blobs can be used for focus particles/fluidic controls in the Green color channel.

The reference measurements included in the UTI Test can serve multiple purposes. The no-growth reference well (e.g., A01) can be used to confirm that the test receives a sufficient inoculum of bacteria, and it also provides the baseline for calculating the extent of growth in all other wells, particularly for the no-antibiotic growth well (e.g., A02) to ensure input bacteria are viable (i.e., they grow in the absence of antibiotic). For example, if a well containing antibiotic produces a number of blobs similar to the no-growth reference well (e.g., A01), this result can indicate that no bacterial growth occurred in the presence of the antibiotic at that concentration.

The no-antibiotic growth reference well (e.g., A02) can be used to demonstrate that the inoculum contains viable bacteria capable of growing within the allotted incubation period (i.e., input cells—if viable—are expected to grow in the absence of antibiotic). This reference also helps account for specimen processing steps, such as removal of boric acid preservative or residual antibiotics, as well as biological factors such as bacteria in lag phase or matrix effects that may otherwise inhibit growth. In addition, the no-antibiotic growth reference well (e.g., A02) result provides the key comparator for calculating relative growth. For example, if a well containing antibiotic shows a number of blobs similar to the no-antibiotic growth reference well (e.g., A02), this result can indicate that bacterial growth occurred in the presence of the antibiotic at that concentration.

In most cases, growth in the antibiotic test wells is expected to be compared to growth in the absence of antibiotic. Image analysis can compute both true blobs and derived blobs for each well and for each color channel that is acquired during processing. The Green channel can be utilized for focus particles, which serve to establish and maintain an accurate focal plane across the imaging field, and can also be analyzed to evaluate background quality and debris discrimination. The focus particles also serve as a fluidics control in cartridge-based assay formats, since improper fluidics (e.g., blocked channel, insufficient specimen volume, etc.) may lead to insufficient reagent bead solubilization and thus the lack of expected signal (i.e., blobs) in the Green channel. The Red channel can be employed for fluorescent in-situ hybridization (FISH) labeled cells, where fluorescent probes hybridize to target ribosomal RNA sequences to permit specific bacterial detection. During analysis, individual pixels above a predefined threshold are grouped into connected regions, and those regions can be subjected to connectivity and debris rules that consider blob size, intensity, and shape metrics. Blobs that conform to expected analyte characteristics are retained as true blobs, while those that fall outside configured tolerances are classified as debris and excluded from the counts. A derived blob value may further be calculated as the total fluorescent intensity of all true blob pixels divided by the expected intensity of a single labeled cell, thereby normalizing signal strength into an equivalent cell count. This dual output allows the system to maintain sensitivity at low cell counts through direct enumeration and to extend the dynamic range at higher concentrations where individual cells may overlap and cannot be distinctly resolved.

The results determination algorithm can determine a categorical susceptibility result of Susceptible(S), Intermediate (I), or Resistant (R) for each antibiotic tested. The algorithm receives as its input values the intermediate determinations of “growth” or “no-growth” that are generated for both the low and high antibiotic concentrations of each drug. These intermediate determinations can be established by comparing the Relative Growth Ratio (RGR) of each antibiotic concentration to a pre-set Relative Growth Threshold (RGT), which can be selected for each bacteria/antibiotic pairing based on training data to optimize agreement with broth microdilution (BMD) reference methods. In practice, with 3-state antibiotics, when no growth is detected at both concentrations, the bacteria can be categorized as susceptible; when growth is observed at the low concentration but not the high concentration, the bacteria can be categorized as intermediate; and when growth is detected at both concentrations, the bacteria can be categorized as resistant. In some instances, an unexpected pattern such as no growth at the low concentration and growth at the high concentration can occur, in which case the result is flagged as invalid for that antibiotic. The low and high concentrations are typically chosen to align with the established susceptible and intermediate breakpoints for 3-state antibiotics (or the highest intermediate concentration if the intermediate zone is more than a single concentration), respectively, such that the two antibiotic concentration design provides sufficient discriminatory power to resolve S, I, and R categories using only two wells per antibiotic. By applying this structured logic across all antibiotic concentrations included in the assay cartridge, the algorithm can generate categorical susceptibility results that are consistent, reproducible, and suitable for clinical interpretation. For 2-state antibiotics, those with only S and R categories (no I), the two antibiotic concentrations are selected at the S breakpoint for the high concentration and 2-fold less for the low concentration.

The UTI test results determination logic can designate a test target as invalid when one or more predefined failure conditions are detected during cartridge processing and analysis. Such conditions may arise from failures in imaging, region identification, fluidic performance, or from inconsistent biological growth outcomes. In particular, a target antibiotic result can be considered invalid if an error is detected in any of the wells associated with the antibiotic target, such as wells A03 through B08 of the cartridge. A focus error can occur when the imaging system cannot establish or maintain an acceptable focal plane using the green-channel focus particles, thereby preventing reliable image capture. A region of interest error can arise when the well edge cannot be confidently located or aligned within the captured image, resulting in an inability to define the analytical region for blob detection and quantitation. A fluidic control error can occur when the fluidics module does not deliver or transfer sample material as expected, which can be detected when the true blob count of the fluidic control wells in the green channel falls outside acceptable ranges. For example, the result can be deemed invalid when the control blob count is less than or equal to a configured fish_flcontrl_threshold_low parameter or greater than a configured fish_flcontrl_threshold_high parameter, each of which may be predetermined from system validation studies.

In addition to imaging and fluidics errors, the determination logic can also evaluate the biological growth outcomes themselves. When a bacterial growth is detected in the presence of the high antibiotic concentration, but no growth is detected in the corresponding lower concentration, the logic can designate that antibiotic target as invalid. This safeguard can prevent spurious results that are inconsistent with established microbiological principles and breakpoint logic. Also, if the relative growth ratio exceeds expected values (for example, growth in the presence of antibiotic should never exceed growth in the absence of antibiotic by a wide margin), the result may be invalid. Beyond the biological validity checks, the computing system can also evaluate analyzer-lever performance conditions that may affect test validity. for example, system errors, such as temperature-control deviations, improper or incomplete mechanical movements (e.g., carousel rotation, pipetting, or optical positioning), reagent-delivery failures, software scheduling errors, and/or power interruptions (among various other system errors) can each cause one or more assays to be invalidated. In some embodiments, the computing device can monitor these conditions through sensors or diagnostic subsystems and automatically flag affected tests as invalid. By implementing validity checks at both: the system level (which can consider factors such as focus, region detection, and fluidics, etc.), analyzer performance (which can consider temperature stability, motion accuracy, and system scheduling, etc.) and at the assay level (which can consider the consistency of the growth patterns, etc.), the determination logic can help ensure that only results generated under proper operating and biological conditions are reported as categorical susceptibility outcomes.

There may be conditions under which the entire UTI test cartridge may be designated as invalid. The determination logic can assign this status if an error is detected in one of the primary reference wells, namely well A01, which serves as the no-growth control, or well A02, which serves as the no-antibiotic growth reference. If either of these wells produces a focus error or a region-of-interest error, the cartridge result cannot be trusted and is therefore considered invalid. A cartridge may also be deemed invalid if the fluidic control performance in these reference wells falls outside acceptable bounds, for example when the true blob count measured in the green channel is less than or equal to the configured fish_flcontrl_threshold_low value or greater than the fish_flcontrl_threshold_high value. In addition to these imaging and fluidic checks, the validity of the cartridge can be assessed by examining the control signals themselves. If the no-growth reference well generates a measurement at or below a lower-limit threshold (NG_ref_LL), the test is considered invalid, since the inoculum baseline cannot be reliably established. Likewise, if the ratio of the no-antibiotic growth reference to the no-growth reference (A02/A01) is at or below a predetermined reference ratio threshold (ref_ratio_LL), then the test cartridge can also be designated invalid, as this condition indicates insufficient growth in the control system to support meaningful interpretation of antibiotic effects (i.e., the input cells did not grow as expected in the absence of antibiotic).

Table 11 provides example validity parameters for the UTI Test:

TABLE 11
Example Validity Parameters for UTI Test Per 5 Hours of Growth

| Parameter | Value | Description |
|---|---|---|
| use_derived_threshold | 12,000 | Use derived blobs if derived blobs are >= this |
| | | value |
| fish_flcontrl_threshold_low | 300 | Fluidic control low blob threshold FISH (Valid |
| | | if>) |
| fish_flcontrl_threshold_high | 8,000 | Fluidic control high blob threshold FISH |
| | | (Valid if≤) |
| NG_ref_LL | 100 | No-growth reference lower limit (Invalid if≤) |
| ref_ratio_LL | 7.5 | Ratio of references (A02 / A01) lower limit |
| | | (Invalid if≤) |
| NG_ref_UL | 20,000 | No-growth reference upper limit (Invalid if>) |

The output generated by image processing for each antibiotic target can be evaluated against the corresponding outputs obtained from the no-growth reference and the no-antibiotic growth reference measurements to determine whether bacterial growth has occurred in the presence of the antibiotic. This evaluation can be performed for both the lower and higher concentration levels associated with the antibiotic under test. The extent of growth can be quantified using relative growth calculations derived from the image analysis data, and the resulting values can be compared to predetermined relative growth thresholds.

For each antibiotic, an antimicrobial susceptibility determination of susceptible, intermediate, or resistant is made based on the intermediate growth results of the low and high concentrations. These results are shown on the Detailed Results Screen. Knowledge of the published breakpoints are required to derive a result. There are two possible cases. Case 1 is where the antibiotic has a 2-state breakpoint, consisting of: a) the concentration at or below which defines susceptible; and b) the concentration (2-fold greater than “a”) at or above which defines resistance. Case 2 is where the antibiotic has a 3-state breakpoint that includes: a) the concentration at or below which defines susceptible; b) one or more concentrations that define intermediate susceptibility; and c) the concentration at or above which defines resistance. Table 13 illustrates how SIR is derived for each of these two cases. For test targets that are valid and are configured to use Two-State Breakpoints, results determination shall be made in accordance with the Case 1 section of Table 13. For test targets that are valid and are configured to use Three-State Breakpoints, results determination shall be made in accordance with the Case 2 section of Table 13.

TABLE 13
Parameters to Determine Categorical Susceptibility for UTI AST-
Direct E. coli Test (Abx concentrations for Case 1 and Case
2 selected relative to established breakpoints as discussed above).

| | | |
|---|---|---|
| Abx low concentration | Abx high concentration | Reported test |
| intermediate result | intermediate result | target result |

Case 1: Two-State Breakpoints

| | | |
|---|---|---|
| No-Growth | No-Growth | Susceptible |
| Growth | No-Growth | Susceptible |
| Growth | Growth | Resistant |
| No-Growth | Growth | Invalid |

Case 2: Three-State Breakpoints

| | | |
|---|---|---|
| No-Growth | No-Growth | Susceptible |
| Growth | No-Growth | Intermediate |
| Growth | Growth | Resistant |
| No-Growth | Growth | Invalid |

Table 14 defines for each antibiotic whether the breakpoints are 2-state or 3-state.

TABLE 14
Example Breakpoint State for Each Antibiotic

| Test target | | Breakpoint State |
|---|---|---|
| (Antibiotic) | Test target (Antibiotic) | (2 or 3) |
| E. coli:Abx1 | AMC (Amox-Clav) | 3 state |
| E. coli:Abx2 | CIP (Ciprofloxacin) | 3 state |
| E. coli:Abx3 | CPD (Cefpodoxime) | 3 state |
| E. coli:Abx4 | CRO (Ceftriaxone) | 3 state |
| E. coli:Abx5 | NIT (Nitrofurantoin) | 3 state |
| E. coli:Abx6 | SXT (Trimeth-sulf) | 2 state |
| E. coli:Abx7 | CFZ (Cefazolin) | 2 state |

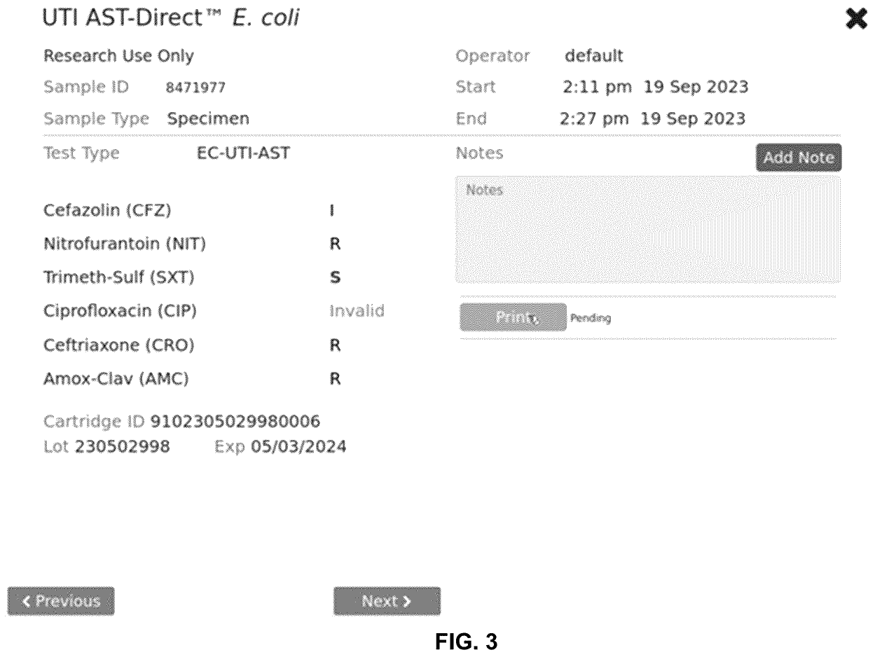

The UTI Test determines the susceptibility of E. coli bacteria to 7 different antibiotics. The “Result” column on the summary results screen will direct the user to the detailed results screen. An example user interface is shown as FIG. 3 (FIG. 3). Shown in FIG. 3 is an example user interface that indicates that the specimen included uropathogens that are resistant to Nitrofurantoin. Ceftriaxone, and Amox-Clav. The user interface can demonstrate that the uropathogen is susceptible to Trimeth-Sulf and is intermediate to Cefazolin. The user interface also demonstrates that the test for Ciprofloxacin was invalid.

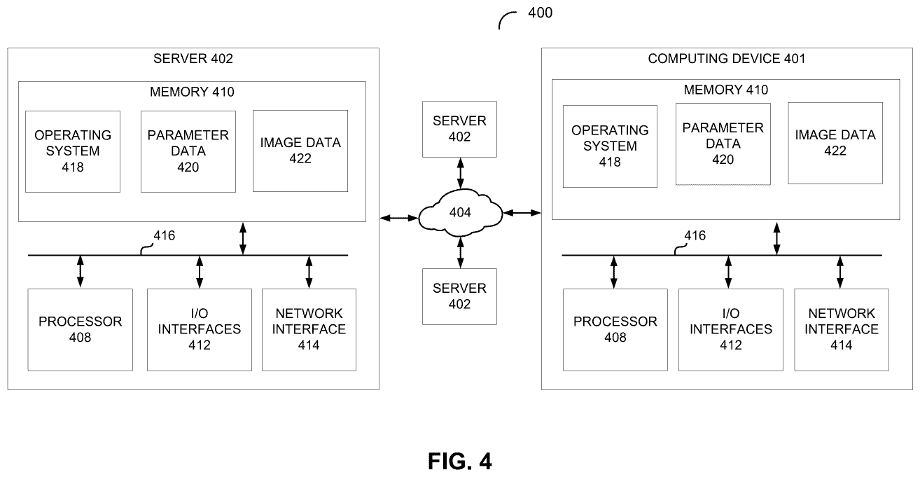

FIG. 4 shows a block diagram depicting an example environment 400 for implementing the present methods and systems. The example environment 400 as shown in FIG. 4 comprises a computing device 401 and a server 402 connected through a network 404. In an aspect, some or all steps of any described method may be performed by the computing device 401 and/or the server 402. The computing device 401 can comprise one or multiple computers configured to store one or more of parameter data 420 (e.g., image processing and analysis parameters, thresholds, etc.) and/or image data 422 (e.g., data related to any of the images described herein). The server 402 can comprise one or multiple computers configured to store the parameter data 420 and/or the image data 422. Multiple servers 402 can communicate with the computing device 401 via the through the network 404.

The computing device 401 and the server 402 may each comprise a digital computer that, in terms of hardware architecture, generally includes a processor 408, memory system 410, input/output (I/O) interfaces 412, and network interfaces 414. These components may be communicatively coupled via a local interface 416. The local interface 416 can be, for example, but not limited to, one or more buses or other wired or wireless connections, as is known in the art. The local interface 416 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 can be a hardware device for executing software, particularly that stored in memory system 410. The processor 408 can be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 can be configured to execute software stored within the memory system 410, to communicate data to and from the memory system 410, and to generally control operations of the computing device 401 and the server 402 pursuant to the software.

The I/O interfaces 412 can be used to receive user input from, and/or for providing system output to, one or more devices or components. User input can be provided via, for example, a keyboard and/or a mouse. System output can be provided via a display device and a printer (not shown). I/O interfaces 412 can include, for example, a serial port, a parallel port, a Small Computer System Interface (SCSI), an infrared (IR) interface, a radio frequency (RF) interface, and/or a universal serial bus (USB) interface.

The network interface 414 can be used to transmit and receive from the computing device 401 and/or the server 402 on the network 404. The network interface 414 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The memory system 410 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 410 may incorporate electronic, magnetic, optical, and/or other types of storage media. Note that the memory system 410 can have a distributed architecture, where various components are situated remote from one another, but can be accessed by the processor 408.

The software in memory system 410 may include one or more software programs, each of which comprises an ordered listing of executable instructions for implementing logical functions. In the example of FIG. 4, the software in the memory system 410 of the computing device 401 can comprise the parameter data 420, the image data 422, and a suitable operating system (O/S) 418. In the example of FIG. 4, the software in the memory system 410 of the server 402 can comprise, the parameter data 420, the image data 422, and a suitable operating system (O/S) 418. The operating system 418 essentially controls the execution of other computer programs and provides scheduling, input-output control, file and data management, memory management, and communication control and related services.

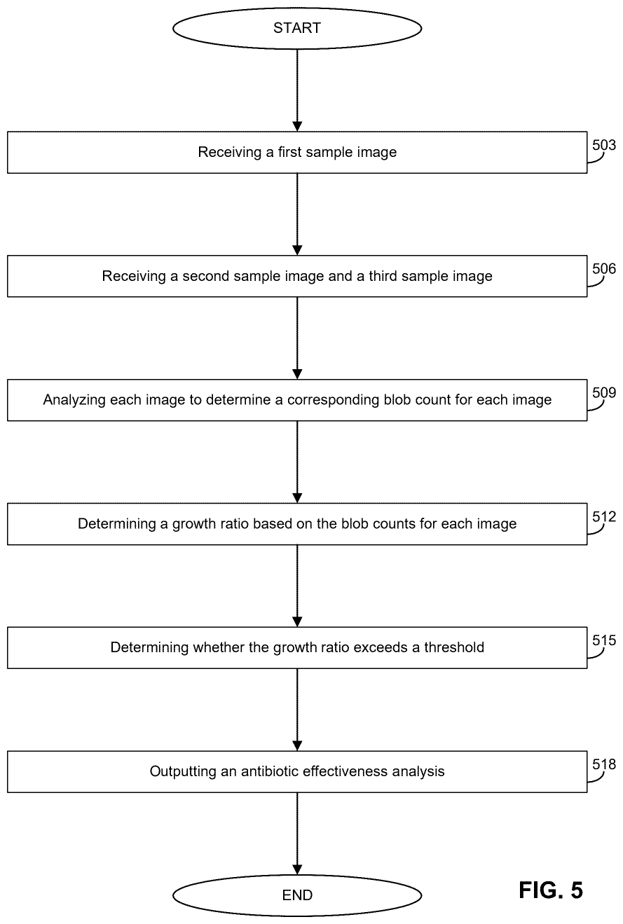

FIG. 5 shows a flowchart that provides one example of functionality performed by a computing system in the example environment 400. The flowchart of FIG. 5 provides merely an example of the many different types of functional arrangements that can be employed to implement the operation of the depicted portion. As an alternative, the flowchart of FIG. 5 can be viewed as depicting an example of elements of a method implemented within the example environment 400.

Beginning with block 503, a computing device (e.g., computing device 401, server 402, etc.) can receive a first sample image. In various embodiments, an instrument (e.g., instrument 201, an analyzer, or a device capable of image capture of the specimen) can capture images of a specimen. An instrument/device used to capture images of the biological specimen can comprise an imaging module configured to detect fluorescent or optical signals associated with labeled cells or particles within a sample well. The instrument/device can include a light source, such as one or more LEDs, to illuminate the specimen, and a detector, such as a digital camera or complementary metal-oxide-semiconductor (CMOS) sensor, to record the emitted or transmitted light. The imaging module may further include optics that direct and focus light onto the detector and may be arranged in a non-magnified or low-magnification configuration to allow a wide field of view for simultaneous capture of multiple targets. In some implementations, the instrument/device can include multiple color channels to separately acquire signals from focus particles and labeled target organisms with different fluorescence spectra, thereby permitting accurate analysis of both reference controls and test wells.

In various embodiments, a biological specimen can be described broadly as a material that originates from a living organism or that contains biological matter derived from such an organism. The specimen can include primary samples such as urine, blood, saliva, or other body fluids collected directly from a subject, as well as secondary samples such as purified colonies, culture preparations, or aliquots obtained after laboratory processing. In the context of diagnostic testing, a biological specimen can therefore encompass any sample material that contains or may contain microbial cells, cellular components, or proteins or nucleic acids suitable for analysis.

The biological specimen can be distributed or portioned into one or more analysis wells, with each well serving as a discrete sample that may be independently processed and evaluated. Partitioning the specimen in this manner can facilitate the parallel assessment of multiple conditions, such as growth in the absence of antibiotic, growth in the presence of antibiotic, or baseline no-growth controls. In certain embodiments, a first sample of the portioned biological specimen can be used to establish an initial reference point for analysis. This initial reference, often referred to as time zero (“T0”), can correspond to a time immediately following receipt of the biological specimen or shortly after the specimen has been processed and prepared for testing. At T0, the specimen generally has not undergone significant microbial replication or change, and therefore serves as a baseline condition that reflects the input inoculum. A first sample image can be captured at this time, and this image can provide information on the number and distribution of detectable, specific target organisms or particles within the specimen prior to any substantial growth. The TO measurement can thus provide an important control for subsequent comparisons, allowing later images to be interpreted relative to the original inoculum and ensuring that growth or inhibition effects are distinguished from the starting baseline. The computing device can be configured to receive or otherwise obtain the first sample image from the instrument capable of capturing images. In at least some embodiments, the computing device may itself be capable of capturing images, in which the act of receiving the first sample image includes capturing the first sample image.

Continuing to block 506, the computing device can receive a second sample image and a third sample image. The second sample image can represent a portion of the specimen that is incubated without exposure to any treatment, such as an antibiotic, and therefore can serve as a growth control that demonstrates the capacity of the pathogen to replicate under favorable conditions (without antibiotic for example). This image is typically acquired after a defined incubation period, referred to as Time X (TX), and can provide a measure of the total growth achieved by the input inoculum in the absence of inhibitory agents. The third sample image can represent a portion of the specimen that is incubated under substantially similar conditions to the second sample, but in the presence of at least one treatment, such as a specific antibiotic or combination of antibiotics and at a specific concentration or concentrations. The computing device can be configured to receive or otherwise obtain the second sample image and the third sample image from the instrument capable of capturing images. In at least some embodiments, the computing device may itself be capable of capturing images, in which the act of receiving the second sample image and the third sample image includes capturing the second sample image and capturing the third sample image.

Continuing to block 509, the computing device can analyze each captured image to determine a corresponding blob count that represents the number of fluorescent objects detected within the image. In various embodiments, the computing device can process images obtained at multiple stages of the assay, including a first sample image taken at time zero (TO), a second sample image obtained after incubation in the absence of treatment, and a third sample image obtained after incubation in the presence of one or more treatments, such as antibiotics. Additional images may also be acquired for different incubation times, different antibiotic concentrations, or alternative reference conditions. Each of these images can be analyzed independently, with the computing device determining a blob count for each image. Thus, a first blob count can be associated with the first sample image, a second blob count can be associated with the second sample image, and a third blob count can be associated with the third sample image. By maintaining a one-to-one correspondence between blob counts and their associated images, the computing device can track the progression of the specimen over time and under different treatment conditions. This association can provide an audit trail that ensures both analytical transparency and regulatory compliance in clinical or laboratory settings.

In some embodiments, the analysis of each image can involve multiple discrete processing stages that are performed in sequence to ensure robust and reproducible results. The computing device can first perform a region of interest (ROI) detection process, which identifies the precise boundaries of the well within the captured image. Because mechanical or optical variations may cause small shifts in image alignment, the ROI detection process can correct for these variations by locating the edges of the well with pixel-level precision. By doing so, the computing device ensures that only the valid portion of the image is processed, excluding irrelevant background pixels. If the ROI cannot be reliably determined, such as when the well edge is not visible or illumination is inconsistent, the computing device can generate an error flag and record the image as invalid for further analysis. Such error detection safeguards the integrity of the downstream analysis by ensuring that subsequent processing steps operate only on valid image data.

Once the ROI has been defined, the computing device can perform preprocessing operations designed to reduce noise and normalize the image background. This preprocessing step can include field flattening, which compensates for uneven illumination, lens artifacts, or camera sensitivity variations. By leveling the background, field flattening ensures that variations in lighting do not artificially elevate or suppress pixel intensities. The result is an image in which true fluorescent signals are more easily distinguished from noise. Following preprocessing, the computing device can apply a threshold analysis, in which each pixel within the ROI is compared to a predefined intensity threshold. Pixels that exceed this threshold are identified as candidate signal pixels, while those below the threshold are treated as background. This step effectively transforms the image into a binary representation of signal versus non-signal, simplifying the process of subsequent object detection.

After thresholding, connectivity analysis can be performed to identify groups of adjacent pixels that collectively exceed the threshold. These connected groups of pixels can be defined as blobs, representing discrete fluorescent objects within the well. The connectivity analysis ensures that each blob corresponds to a unique fluorescent entity, preventing adjacent signals from being erroneously merged or fragmented. Each blob can be characterized by properties such as pixel count, perimeter, centroid, and overall shape. To further refine this set of candidate blobs, the computing device can apply debris analysis. In this stage, each blob is evaluated according to a set of metrics that can include size, average intensity, and shape parameters. Blobs that do not conform to expected analyte characteristics, such as those that are too small, too dim, or irregularly shaped, can be classified as debris and excluded from the final count. The specific rules used for debris analysis may be defined in a test definition file and can be configured for different assay types, bacterial species, or imaging conditions. This rule-based filtering provides flexibility to adapt the analysis algorithm to new test parameters without requiring changes to the underlying software.

The final outputs of image analysis can include both a “True Blob” count and a “Derived Blob” value. The true blob count represents the number of valid fluorescent objects remaining after debris removal. This value is particularly important when cell concentrations are low, since direct enumeration of individual organisms provides an accurate measure of the number of cells in each independent reaction. In parallel, the computing device can calculate a derived blob value by summing the total pixel intensities of all true blobs and dividing that sum by the expected intensity of a single reference blob. The derived blob value provides a normalized measure that extends the dynamic range of the assay, enabling accurate quantification even when cell concentrations are high and individual blobs merge into clusters or a single large cluster in extreme cases. The use of both true and derived blob outputs therefore allows the computing device to maintain accuracy across a wide range of bacterial concentrations, from sparse inputs to dense cultures. Together, these analysis steps can transform raw image data into biologically meaningful measurements. The ROI detection step ensures spatial accuracy, field flattening and thresholding provide signal normalization, connectivity analysis translates signal pixels into discrete entities, debris analysis ensures quality control, and the dual outputs of true and derived blob counts provide complementary measures of microbial presence.

In some embodiments, the image analysis can further evaluate morphological changes in the bacterial cells that occur under selective pressure from antibiotics. A prominent example of such a morphological response is filamentation, in which bacterial cells undergo elongation rather than completing normal cell division. Filamentation can result in cells that appear significantly longer than expected for the target organism, forming elongated structures instead of compact rods or cocci. The formation, length, number, and labeling intensity of filaments can depend on the bacterial species, the specific antibiotic, and the antibiotic concentration.

The occurrence of filamentation can provide additional diagnostic value because it frequently arises when a bacterial strain is susceptible to the tested antibiotic. For instance, β-lactam antibiotics can induce filamentation in E. coli as an intermediate stress response before cell lysis occurs. In contrast, resistant strains often continue to divide and maintain typical morphology, even in the presence of antibiotic. By analyzing morphological features, such as blob aspect ratio, compactness, and perimeter-to-area ratios, the computing device can detect the presence of filamentous cells within a sample image. Detection of filamentation therefore extends the interpretive power of the system beyond simple blob counts. Whereas blob counts and derived intensities provide quantitative measures of growth, morphological analysis of filamentation provides a qualitative marker of antibiotic activity. This can enable earlier recognition of susceptibility, even before total biomass reduction is measurable. In some embodiments, filamentation detection can be combined with growth ratio determinations and incorporated into classifier-based algorithms, thereby enhancing both the speed and the reliability of the susceptibility analysis.

Continuing to block 512, the computing device can determine a growth ratio based on the blob counts for each image. In various embodiments, the computing device can associate the blob counts derived from the no-antibiotic growth reference (e.g., the second sample) with blob counts derived from the treated growth reference (e.g., the third sample) to calculate growth ratios. In various embodiments, this growth ratio can be expressed as a relative growth ratio (RGR), which represents the effect of an antibiotic treatment on microbial proliferation as compared to an untreated growth control. The RGR provides a normalized measure of growth and allows for consistent interpretation across different bacterial species and antibiotic classes.

The RGR can be defined as the ratio of signals in the presence and absence of antibiotic after an incubation period sufficient to permit bacterial replication. More rigorously, RGR can be calculated as the ratio of growth ratios measured with and without antibiotic, where the common no-growth reference term cancels out of the equation. For a typical four-hour incubation step at 35° C., the RGR can be determined according to the following relationship:

$$Relative growth ratio ( RGR ) = \frac{growth with Abx}{growth without Abx} = \frac{Sample 3 Blob Count / Sample 1 Blob Count}{Sample 2 Blob Count / Sample 1 Blob Count}$$

Here, “Sample 1 Blob Count” represents the baseline blob count obtained from the first sample image which represents the biological specimen prior to incubation. “Sample 3 Blob Count” represents the blob count obtained from the third sample image after incubation in the presence of antibiotic. “Sample 2 Blob Count” represents the blob count obtained from the second sample image after incubation in the absence of antibiotic. Because the baseline inoculum cancels from the ratio, the final expression can simplify to the ratio of the treated versus untreated growth signals. The resulting RGR can be expressed as a percentage to aid interpretability. In some embodiments, Sample 1 (e.g., T0) may not be required in the flowchart of FIG. 5, however it may be used as a validity check to ensure valid results.

When an antibiotic has little or no impact on bacterial replication, the number of cells detected after incubation in the presence of antibiotic can be similar to the number detected in the untreated growth control. In such cases, the RGR will be close to one-hundred percent (100%), reflecting minimal inhibition. In contrast, when an antibiotic prevents bacterial growth or actively kills the input cells, the signal from the treated condition will be substantially lower than the untreated control, producing an RGR closer to zero percent (0) %). The ability to compress results into a single normalized ratio thus provides a robust way to distinguish between effective and ineffective antimicrobial activity. By implementing the RGR framework, the computing device can transform raw blob counts into normalized growth measures (growth ratios) that are comparable across wells, timepoints, and treatment conditions.

Continuing to block 515, the computing device can determine whether the growth ratio exceeds a threshold. Once the growth ratio (e.g., RGR) has been calculated for a given bacteria/antibiotic combination, the computing device can determine whether the RGR exceeds a pre-established growth threshold. Each threshold can be derived from training datasets in which experimental RGR values are compared to reference results, such as those obtained by broth microdilution (BMD). These datasets can be used to identify cut-off points that yield the highest categorical agreement between the new system described herein and the reference standard.

In practical implementation, RGR thresholds depend on the specific bacterial species and the antibiotic being tested. In other words, each specific uropathogen/drug combination may have a specified RGR threshold that is customized to that uropathogen/drug combination. For example, the RGR threshold may be different for one single drug (e.g., antibiotic) as it applies to two different uropathogens. Likewise, the RGR threshold may be different for one single uropathogen as it applies to two or more drugs (e.g., antibiotics). The threshold values may vary across different antibiotics and uropathogens (bacterial species), reflecting the unique growth kinetics and mechanisms of inhibition that characterize each combination. Preliminary validation studies indicate that RGR thresholds commonly fall within the range of about fifteen percent (15%) to thirty percent (30%), however other values outside this range are possible. For example, at least one exemplary threshold has been set as low as four percent 4% for at least one drug and uropathogen combination, and another exemplary threshold has been set to 35% or higher for another drug and uropathogen combination. Having an RGR for a sample that is greater than or equal to the defined threshold can be interpreted as bacterial growth in the presence of antibiotic, while having an RGR for a sample that is below the threshold can be interpreted as inhibition or killing of the bacteria.

The decision logic can be implemented such that the computed RGR is evaluated against the stored threshold parameter. If the RGR is greater than or equal to the threshold, the result can be classified as “growth” in the presence of the antibiotic, meaning that the antibiotic did not sufficiently inhibit proliferation under the test conditions. Conversely, if the RGR is less than the threshold, the result can be classified as “no-growth,” indicating that the antibiotic prevented replication or killed the bacterial inoculum. For example, where an RGR threshold has been established at 20% for a particular species/antibiotic combination, an observed RGR of 25% would be interpreted as growth, while an observed RGR of 15% would be interpreted as no-growth.

In some implementations, the RGR and the associated threshold can be expressed as percentages to simplify interpretation. An RGR approaching 100% can correspond to growth similar to untreated controls, while an RGR approaching 0% can correspond to complete inhibition. This determination step ensures that the analysis is not based solely on absolute cell counts, which can vary depending on input inoculum or imaging conditions, but instead on normalized growth behavior relative to untreated controls. By anchoring growth determination to an empirically validated threshold, the system can provide reproducible and clinically relevant results that align with standard interpretive criteria.

Continuing to block 518, the computing device can output an antibiotic effectiveness analysis. Once growth has been determined using the relative growth ratio (RGR) calculations (in various embodiments, for each antibiotic and each antibiotic concentration) and those values have been compared to the RGR thresholds established for the relevant bacteria/antibiotic combination, the computing device can assign a categorical interpretation of the antimicrobial effect. The categorical result can indicate whether the microorganism is susceptible(S) or resistant (R) to the tested antibiotic, or whether the test was invalid. When the growth ration exceeds the threshold, it can be said that the microorganism is resistant to the treatment (e.g., antibiotic). When the growth ration fails to exceed the threshold, it can be said that the microorganism is susceptible to the treatment (e.g., antibiotic).

In some embodiments, the result may indicate that the test was invalid. A test can be designated as invalid when one or more predefined error conditions prevent the computing device from generating a reliable susceptibility determination. Invalidity can occur at different levels of the assay, including the cartridge as a whole, individual reference wells, or antibiotic-specific result wells. At the cartridge level, the system can assess reference wells, such as the no-growth control and the no-antibiotic growth control, to ensure that proper baseline and growth conditions exist. If the no-growth control produces a signal below a predetermined lower limit or if the no-antibiotic control does not demonstrate sufficient proliferation relative to the no-growth reference, the cartridge can be considered invalid because these controls no longer provide a valid baseline for comparison. Similarly, if imaging errors such as focus errors, region-of-interest errors, or fluidic control errors occur in the reference wells, the cartridge may be invalidated since reliable interpretation cannot be established. At the antibiotic-specific level, invalidity can occur if growth patterns conflict with biological expectations. In addition to biological inconsistencies, software-based checks can invalidate results when the image analysis does not meet quality thresholds. For example, if the blob counts fall outside the configured thresholds for fluidic or imaging performance, or if debris analysis indicates excessive background noise, the computing device can mark the associated result as invalid. These quality control parameters can be configured within the test definition file to adapt to specific assay conditions.

Once the categorical determination is made, the computing device can output the antibiotic effectiveness analysis to one or more computing systems. For example, the result can be displayed on a user interface associated with the analyzer itself, showing the tested antibiotic and its corresponding S/R designation. In some embodiments, the computing device can generate both summary views, which present only the categorical interpretation, and detailed views, which include the underlying image metrics, blob counts, fold growth ratios, RGR values, and threshold comparisons used to generate the categorical result. This allows operators to review the data at different levels of granularity, depending on clinical or regulatory requirements.

The antibiotic effectiveness analysis can also be transmitted electronically to other computing devices, such as laboratory information systems (LIS), hospital information systems (HIS), or electronic medical record (EMR) systems, using standard data formats and communication protocols. In such cases, the computing device can package the S/R results with metadata, such as the bacterial species, test identification, cartridge identifier, and processing timestamp. This ensures that the results are integrated into broader clinical workflows and can be accessed by healthcare providers in real time.

In some implementations, the output may include additional interpretive flags or recommendations. For example, when resistance is detected to first-line antibiotics, the computing device can highlight alternative therapies tested in the panel. Likewise, when an invalid result is recorded for a particular antibiotic, the output can indicate that no valid interpretation was possible, prompting retesting or reflex to a reference method. By structuring the antibiotic effectiveness analysis in this way, the computing device provides not only categorical susceptibility outcomes but also the context necessary to guide accurate clinical decision-making.

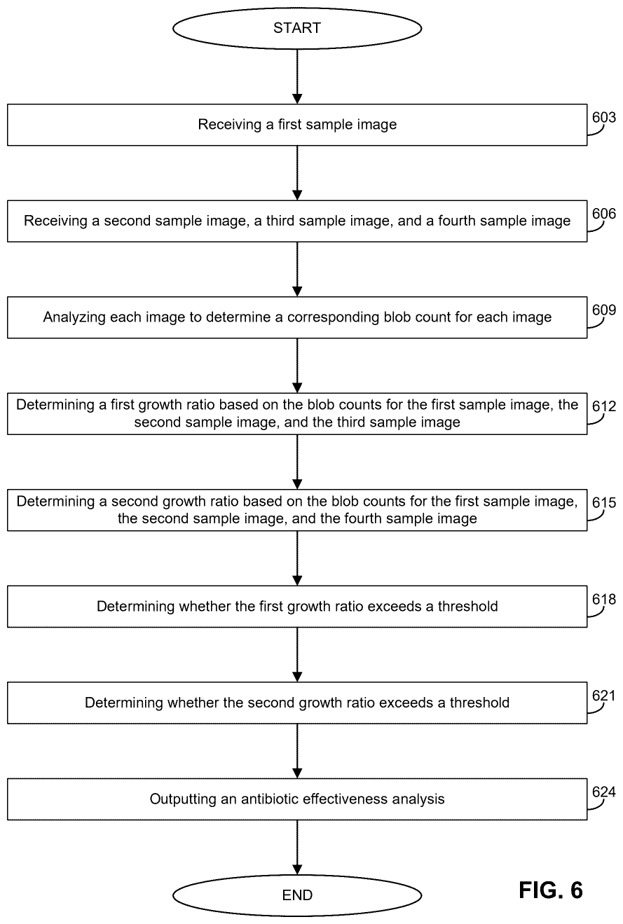

FIG. 6 shows a flowchart that provides one example of functionality performed by a computing system in the example environment 400. The flowchart of FIG. 6 provides merely an example of the many different types of functional arrangements that can be employed to implement the operation of the depicted portion. As an alternative, the flowchart of FIG. 6 can be viewed as depicting an example of elements of a method implemented within the example environment 400.

Beginning with block 603, a computing device (e.g., computing device 401, server 402, etc.) can receive a first sample image. In various embodiments, an instrument (e.g., instrument 201, an analyzer, or a device capable of image capture of the specimen) can capture images of a specimen. An instrument/device used to capture images of the biological specimen can comprise an imaging module configured to detect fluorescent or optical signals associated with labeled cells or particles within a sample well. The instrument/device can include a light source, such as one or more LEDs, to illuminate the specimen, and a detector, such as a digital camera or complementary metal-oxide semiconductor (CMOS) sensor, to record the emitted or transmitted light. The imaging module may further include optics that direct and focus light onto the detector and may be arranged in a non-magnified or low-magnification configuration to allow a wide field of view for simultaneous capture of multiple targets. In some implementations, the instrument/device can include multiple color channels to separately acquire signals from focus particles and labeled target organisms, thereby permitting accurate analysis of both reference controls and test wells.

In various embodiments, a biological specimen can be described broadly as a material that originates from a living organism or that contains biological matter derived from such an organism. The specimen can include primary samples such as urine, blood, saliva, or other body fluids collected directly from a subject, as well as secondary samples such as purified colonies, culture preparations, or aliquots obtained after laboratory processing. In the context of diagnostic testing, a biological specimen can therefore encompass any sample material that contains or may contain microbial cells, cellular components, or nucleic acids suitable for analysis.

The biological specimen can be distributed or portioned into one or more analysis wells, with each well serving as a discrete sample that may be independently processed and evaluated. Partitioning the specimen in this manner can facilitate the parallel assessment of multiple conditions, such as growth in the absence of antibiotic, growth in the presence of antibiotic, or baseline no-growth controls. In certain embodiments, a first sample of the portioned biological specimen can be used to establish an initial reference point for analysis. This initial reference, often referred to as time zero (“TO”), can correspond to a time immediately following receipt of the biological specimen or shortly after the specimen has been processed and prepared for testing. At TO, the specimen generally has not undergone significant microbial replication or change, and therefore serves as a baseline condition that reflects the input inoculum. A first sample image can be captured at this time, and this image can provide information on the number and distribution of detectable organisms or particles within the specimen prior to any substantial growth. The TO measurement can thus provide an important control for subsequent comparisons, allowing later images to be interpreted relative to the original inoculum and ensuring that growth or inhibition effects are distinguished from the starting baseline. The computing device can be configured to receive or otherwise obtain the first sample image from the instrument capable of capturing images. In at least some embodiments, the computing device may itself be capable of capturing images, in which the act of receiving the first sample image includes capturing the first sample image.

Continuing to block 606, the computing device can receive a second sample image, a third sample image, and a fourth sample image. The second sample image can represent a portion of the specimen that is incubated without exposure to any treatment (e.g., antibiotics) and therefore can serve as a no-antibiotic growth control that demonstrates the capacity of the microorganism to replicate under favorable conditions. This image is typically acquired after a defined incubation period, referred to as Time X (TX), and can provide a measure of growth achieved by the input inoculum in the absence of inhibitory agents. The third sample image can represent a portion of the specimen that is incubated under substantially similar conditions to the second sample but in the presence of at least one treatment, such as a specific antibiotic or combination of antibiotics. The fourth sample image can represent a further treated portion of the specimen and can, in various embodiments, correspond to a different concentration of the same antibiotic or combination used for the third sample (e.g., a high-versus-low concentration comparison), or can correspond to a different antibiotic or antibiotic combination altogether to enable parallel assessment of multiple therapies. In some implementations, the third and fourth samples can be incubated for the same TX to facilitate direct comparison (e.g., The computing device can be configured to receive or otherwise obtain the second, third, and fourth sample images from an instrument capable of capturing images of the specimen). In at least some embodiments, the computing device may itself capture these images, such that receiving the sample images includes capturing the second sample image, capturing the third sample image, and capturing the fourth sample image.

Continuing to block 609, the computing device can analyze each image to determine a corresponding blob count for each image. The computing device can analyze each captured image to determine a corresponding blob count that represents the number of fluorescent objects detected within the image. In various embodiments, the computing device can process images obtained at multiple stages of the assay, including a first sample image taken at time zero (TO), a second sample image obtained after incubation in the absence of treatment, a third sample image obtained after incubation in the presence of at least one treatment, such as an antibiotic, and a fourth sample image obtained under a second treatment condition. The fourth treatment condition can, in some embodiments, represent either a different concentration of the same antibiotic (e.g., a high-versus-low concentration comparison) or a different antibiotic or combination of antibiotics altogether. Additional images may also be acquired for different incubation times, different antibiotic concentrations, or alternative reference conditions. Each of these images can be analyzed independently, with the computing device determining a blob count for each image. Thus, a first blob count can be associated with the first sample image, a second blob count can be associated with the second sample image, a third blob count can be associated with the third sample image, and a fourth blob count can be associated with the fourth sample image. By maintaining a one-to-one correspondence between blob counts and their associated images, the computing device can track the progression of the specimen over time and under different treatment conditions. This association can provide an audit trail that ensures both analytical transparency and regulatory compliance in clinical or laboratory settings.

In some embodiments, the analysis of each image can involve multiple discrete processing stages that are performed in sequence to ensure robust and reproducible results. The computing device can first perform a region of interest (ROI) detection process, which identifies the precise boundaries of the well within the captured image. Because mechanical or optical variations may cause small shifts in image alignment, the ROI detection process can correct for these variations by locating the edges of the well with pixel-level precision. By doing so, the computing device ensures that only the valid portion of the image is processed, excluding irrelevant background pixels. If the ROI cannot be reliably determined, such as when the well edge is not visible or illumination is inconsistent, the computing device can generate an error flag and record the image as invalid for further analysis. Such error detection safeguards the integrity of the downstream analysis by ensuring that subsequent processing steps operate only on valid image data.

Once the ROI has been defined, the computing device can perform preprocessing operations designed to reduce noise and normalize the image background. This preprocessing step can include field flattening, which compensates for uneven illumination, lens artifacts, or camera sensitivity variations. By leveling the background, field flattening ensures that variations in lighting do not artificially elevate or suppress pixel intensities. The result is an image in which true fluorescent signals are more easily distinguished from noise. Following preprocessing, the computing device can apply a threshold analysis, in which each pixel within the ROI is compared to a predefined intensity threshold. Pixels that exceed this threshold are identified as candidate signal pixels, while those below the threshold are treated as background. This step effectively transforms the image into a binary representation of signal versus non-signal, simplifying the process of subsequent object detection.

After thresholding, connectivity analysis can be performed to identify groups of adjacent pixels that collectively exceed the threshold. These connected groups of pixels can be defined as blobs, representing discrete fluorescent objects within the well. The connectivity analysis ensures that each blob corresponds to a unique fluorescent entity, preventing adjacent signals from being erroneously merged or fragmented. Each blob can be characterized by properties such as pixel count, perimeter, centroid, and overall shape. To further refine this set of candidate blobs, the computing device can apply debris analysis. In this stage, each blob is evaluated according to a set of metrics that can include size, average intensity, and shape parameters. Blobs that do not conform to expected analyte characteristics, such as those that are too small, too dim, or irregularly shaped, can be classified as debris and excluded from the final count. The specific rules used for debris analysis may be defined in a test definition file and can be configured for different assay types, bacterial species, or imaging conditions. This rule-based filtering provides flexibility to adapt the analysis algorithm to new test parameters without requiring changes to the underlying software.

The final outputs of image analysis can include both a “True Blob” count and a “Derived Blob” value. The true blob count represents the number of valid fluorescent objects remaining after debris removal. This value is particularly important when cell concentrations are low since direct enumeration of individual organisms provides an accurate measure of the inoculum. In parallel, the computing device can calculate a derived blob value by summing the total pixel intensities of all true blobs and dividing that sum by the expected intensity of a single reference blob. The derived blob value provides a normalized measure that extends the dynamic range of the assay, enabling accurate quantification even when cell concentrations are high and individual blobs merge into clusters. The use of both true and derived blob outputs therefore allows the computing device to maintain accuracy across a wide range of bacterial concentrations, from sparse inputs to dense cultures. Together, these analysis steps can transform raw image data into biologically meaningful measurements. The ROI detection step ensures spatial accuracy, field flattening and thresholding provide signal normalization, connectivity analysis translates signal pixels into discrete entities, debris analysis ensures quality control, and the dual outputs of true and derived blob counts provide complementary measures of microbial presence.

In various embodiments, the computing device can associate the blob counts derived from the no-antibiotic growth reference (e.g., the second sample), the low-concentration antibiotic wells (e.g., the third sample, etc.), and the high-concentration antibiotic wells (e.g., the fourth sample, etc.) to calculate growth ratios (see blocks 612 and 615). A first growth ratio can correspond to the comparison of the low-concentration antibiotic well against the reference wells (see block 612), and a second growth ratio can correspond to the comparison of the high-concentration antibiotic well against the reference wells (see block 615). These growth ratios can then be compared against predetermined thresholds to output categorical susceptibility interpretations such as Susceptible(S), Intermediate (I), or Resistant (R) (see blocks 618, 621, and 624).

Continuing to block 612, the computing device can determine a first growth ratio based on the blob counts for each image. In various embodiments, this first growth ratio can be expressed as a relative growth ratio (RGR), which represents the effect of a first antibiotic treatment condition on microbial proliferation as compared to an untreated growth control. The RGR provides a normalized measure of inhibition that accounts for the input inoculum and allows for consistent interpretation across different bacterial species and antibiotic classes.

The first RGR can be defined as the ratio of signals in the presence and absence of antibiotic after an incubation period sufficient to permit bacterial replication. More rigorously, RGR can be calculated as the ratio of growth ratios measured with and without antibiotic, where the common no-growth reference term cancels out of the equation. For a typical four-hour incubation step at 35° C., the first RGR can be determined according to the following relationship:

$$Relative growth ratio ( RGR ) = \frac{growth with Abx}{growth without Abx} = \frac{Sample 3 Blob Count / Sample 1 Blob Count}{Sample 2 Blob Count / Sample 1 Blob Count}$$

Here, “Sample 1 Blob Count” represents the baseline blob count obtained from the first sample image, which reflects the biological specimen prior to incubation. “Sample 3 Blob Count” represents the blob count obtained from the third sample image after incubation in the presence of antibiotic. “Sample 2 Blob Count” represents the blob count obtained from the second sample image after incubation in the absence of antibiotic. Because the baseline inoculum cancels from the ratio, the final expression simplifies to the ratio of the treated versus untreated growth signals. The resulting first RGR can be expressed as a percentage to aid interpretability.

When an antibiotic has little or no impact on bacterial replication, the number of cells detected after incubation in the treated condition can be similar to the number detected in the untreated growth control. In such cases, the first RGR will be close to one hundred percent (100%), reflecting minimal inhibition. In contrast, when the antibiotic prevents bacterial growth or actively kills the input cells, the signal from the treated condition will be lower than the untreated control, producing a first RGR closer to zero percent (0%). The ability to compress results into a single normalized ratio thus provides a robust way to distinguish between effective and ineffective antimicrobial activity. By implementing the RGR framework, the computing device can transform raw blob counts into normalized growth measures that are comparable across wells, timepoints, and treatment conditions.

Continuing to block 615, the computing device can determine a second growth ratio based on the blob counts for the first sample image, the second sample image, and the fourth sample image. In various embodiments, this second growth ratio can be expressed as a relative growth ratio (RGR), which represents the effect of a second antibiotic treatment condition on microbial proliferation as compared to an untreated growth control. The second RGR provides a normalized measure of inhibition that accounts for the input inoculum and allows for consistent interpretation across different bacterial species and antibiotic classes.

The second RGR can be defined as the ratio of signals in the presence and absence of antibiotic after an incubation period sufficient to permit bacterial replication. More rigorously, RGR can be calculated as the ratio of growth ratios measured with and without antibiotic, where the common no-growth reference term cancels out of the equation. For a typical four-hour incubation step at 35° C., the second RGR can be determined according to the following relationship:

$$Relative growth ratio ( RGR ) = \frac{growth with Abx}{growth without Abx} = \frac{Sample 4 Blob Count / Sample 1 Blob Count}{Sample 2 Blob Count / Sample 1 Blob Count}$$

Here, “Sample 1 Blob Count” represents the baseline blob count obtained from the first sample image, which reflects the biological specimen prior to incubation. “Sample 4 Blob Count” represents the blob count obtained from the fourth sample image after incubation in the presence of antibiotic. “Sample 2 Blob Count” represents the blob count obtained from the second sample image after incubation in the absence of antibiotic. Because the baseline inoculum cancels from the ratio, the final expression simplifies to the ratio of the treated versus untreated growth signals. The resulting second RGR can be expressed as a percentage to aid interpretability.

When an antibiotic has little or no impact on bacterial replication, the number of cells detected after incubation in the treated condition of the fourth sample can be similar to the number detected in the untreated growth control. In such cases, the second RGR will be close to one hundred percent (100%), reflecting minimal inhibition. In contrast, when the antibiotic prevents bacterial growth or actively kills the input cells, the signal from the treated condition will be substantially lower than the untreated control, producing a second RGR closer to zero percent (0) %). By implementing this framework, the computing device can transform raw blob counts into normalized growth measures that can be compared consistently across wells, timepoints, and treatment conditions.

Continuing to block 618, the computing device can determine whether the first growth ratio exceeds a threshold. Once the first relative growth ratio (RGR) has been calculated for a given bacteria/antibiotic combination, the computing device can compare the computed value to a pre-established growth threshold associated with that particular organism and antibiotic. Each threshold can be derived from training datasets in which experimental RGR values are benchmarked against reference results, such as those obtained by the broth microdilution (BMD) method. These datasets can be analyzed to identify cut-off points that yield the highest categorical agreement between the automated system and the gold-standard reference method.

In practical use, thresholds for the first RGR are not universal, but instead can vary depending on the bacterial species and the antibiotic being evaluated. The threshold values may therefore differ across species and treatment conditions, reflecting differences in growth kinetics and the mechanisms of inhibition characteristic of each drug. Preliminary validation studies indicate that thresholds for RGR values typically fall within a range of about fifteen percent (15%) to thirty percent (30%), although other values are possible. A first RGR greater than or equal to the defined threshold can be interpreted as evidence of bacterial growth in the presence of the antibiotic, while a first RGR below the threshold can be interpreted as inhibition or killing of the bacteria.

The decision logic applied by the computing device can therefore be implemented as a comparison operation in which the calculated first RGR is evaluated against the stored threshold parameter. If the first RGR is greater than or equal to the threshold, the result can be classified as “growth” under the treatment condition associated with the third sample. Conversely, if the first RGR is less than the threshold, the result can be classified as “no-growth.” indicating that the antibiotic successfully inhibited replication or killed the input inoculum. For example, if the threshold is set at 20% for a given species/antibiotic combination, and the computed first RGR is 25%, the condition would be interpreted as growth, whereas a computed value of 15% would be interpreted as no-growth.

In some embodiments, the first RGR and the threshold can be expressed as percentages for simplified interpretation. A first RGR approaching one hundred percent (100%) can correspond to growth similar to the untreated control, while a first RGR approaching zero percent (0) %) can correspond to near-complete inhibition. By structuring the determination in this way, the computing device ensures that growth assessment is not based solely on absolute blob counts, which may vary with inoculum size or imaging conditions, but is instead grounded in normalized behavior relative to untreated controls. This allows for reproducible and clinically meaningful outcomes that align with established interpretive standards.

Continuing to block 621, the computing device can determine whether the second growth ratio exceeds a threshold. Once the second relative growth ratio (RGR) has been calculated for the bacteria/antibiotic combination under evaluation, the computing device can compare this value to a pre-established growth threshold. As with the first growth ratio, the threshold can be determined from training datasets in which experimentally observed RGR values are compared against results generated by a reference method, such as broth microdilution (BMD). These datasets allow for the identification of threshold values that yield the highest categorical agreement with reference standards, ensuring that the automated analysis provides reliable and clinically valid interpretations.

The threshold associated with the second growth ratio may differ from that used for the first growth ratio, since thresholds are defined for each bacterial species and antibiotic or antibiotic combination individually. In other words, if the drug (e.g., antibiotic) or the uropathogen (e.g., bacteria) of the second growth ratio differs from the first growth ratio, then the second growth threshold may differ. Such variability reflects differences in growth characteristics of microorganisms as well as drug-specific mechanisms of action. In many cases, second RGR thresholds are within a range of about fifteen percent (15%) to thirty percent (30%), although the precise value may be higher or lower depending on the drug and species involved. A second RGR that is greater than or equal to the applicable threshold can be interpreted as “growth” in the treated condition of the fourth sample, indicating that the antibiotic did not sufficiently inhibit replication. Conversely, a second RGR that is less than the threshold can be interpreted as “no-growth,” indicating that the antibiotic successfully inhibited or killed the microorganism.

In practice, the computing device can apply a decision logic in which the second RGR is evaluated against the stored threshold parameter. If the computed second RGR is greater than or equal to the threshold, the computing device can classify the fourth sample condition as exhibiting growth. If the computed second RGR is less than the threshold, the condition can be classified as no-growth. For example, if the threshold for a given antibiotic/bacteria combination is established at 25%, then a second RGR of 30% would be interpreted as growth, while a second RGR of 15% would be interpreted as no-growth.

In some implementations, the second RGR and threshold can be expressed as percentages to simplify interpretation and to provide results that align with standardized reporting conventions. A second RGR close to one hundred percent (100%) can reflect growth similar to the untreated control, while a second RGR close to zero percent (0) %) can reflect near-complete inhibition. This structured approach ensures that the interpretation of the fourth sample condition is not dependent on raw counts, which may vary with input inoculum or technical factors, but rather on normalized growth behavior. By anchoring the analysis of the second growth ratio to empirically validated thresholds, the computing device can provide reproducible and clinically meaningful interpretations across diverse bacterial species and antibiotic combinations.

Continuing to block 624, the computing device can output an antibiotic effectiveness analysis. The computing device can output an antibiotic effectiveness analysis. Once the first and second growth ratios have been calculated and compared against their respective thresholds, the computing device can derive categorical determinations of antimicrobial effectiveness. The categorical result can be expressed in terms of susceptibility(S), intermediate susceptibility (I), resistance (R), or invalidity, depending on the observed growth behavior under the treatment conditions.

In a first embodiment, where the third and fourth samples represent different concentrations of the same antibiotic or antibiotic combination, the computing device can determine an S/I/R value by comparing the first growth ratio (low concentration) and the second growth ratio (high concentration). For example, when growth is inhibited at both low and high concentrations, the microorganism can be classified as susceptible to the antibiotic. When growth occurs at the low concentration but is inhibited at the high concentration, the microorganism can be classified as intermediate. When growth occurs at both concentrations, the microorganism can be classified as resistant. In some cases, paradoxical outcomes may arise, such as inhibition at the low concentration but growth at the high concentration. Because such outcomes cannot be reconciled with known pharmacological behavior, the test for that antibiotic can be classified as invalid. This concentration-dependent interpretation allows the system to emulate established breakpoint-based interpretive criteria while leveraging image-based growth ratio determinations.

In a second embodiment, where the third and fourth samples represent two different antibiotics or antibiotic combinations, the computing device can output independent susceptibility calls for each antibiotic. The first growth ratio can be used to determine the categorical result for the first antibiotic, while the second growth ratio can be used to determine the categorical result for the second antibiotic. For example, the system may determine that the microorganism is resistant to the first antibiotic but susceptible to the second, or resistant to both, or susceptible to both, depending on the calculated ratios relative to their respective thresholds. In this embodiment, each antibiotic is reported independently, but the results may be presented together in a consolidated output to highlight available therapeutic options.

In some embodiments, results may indicate that the test is invalid. A test can be designated as invalid when one or more predefined error conditions prevent reliable interpretation. Invalidity can occur at the cartridge level, such as when the no-growth reference or no-antibiotic control fails to provide valid baseline values. Invalidity can also occur at the antibiotic-specific level, such as when paradoxical growth patterns are detected or when blob counts fall outside configured performance thresholds. When invalidity is determined, the computing device can flag the affected antibiotic or cartridge, preventing the generation of misleading results and prompting a repeat test or confirmatory testing.

Once the categorical determinations are made, the computing device can output the antibiotic effectiveness analysis to one or more computing systems. For example, results can be displayed on a user interface associated with the analyzer itself, showing each tested antibiotic (or concentration condition) alongside its corresponding susceptibility category. The computing device can also generate detailed views, including raw blob counts, calculated growth ratios, threshold comparisons, and metadata such as incubation times or test identifiers. In some implementations, the analysis can be transmitted electronically to laboratory information systems (LIS), hospital information systems (HIS), or electronic medical records (EMRs), ensuring integration into broader clinical workflows. The data packages can include both categorical outcomes (S/I/R/invalid) and supporting metadata such as the bacterial species, test cartridge identifier, and processing timestamp, allowing clinicians to access results in real time.

The antibiotic effectiveness analysis may also include additional interpretive content. For example, when resistance is detected to a first-line antibiotic, the computing device can highlight susceptibility to alternative antibiotics tested in the same cartridge. Likewise, when invalid results occur, the output can indicate that no valid interpretation was possible, guiding laboratory staff to perform retesting or reflex testing by reference methods. By structuring outputs in this way, the system provides not only categorical susceptibility outcomes but also contextual information that supports accurate, efficient, and clinically meaningful decision-making.

Once the categorical determination is made, the computing device can output the antibiotic effectiveness analysis to one or more computing systems. For example, the result can be displayed on a user interface associated with the analyzer itself, showing the tested antibiotic and its corresponding S/I/R designation. In some embodiments, the computing device can generate both summary views, which present only the categorical interpretation, and detailed views, which include the underlying image metrics, blob counts, fold growth ratios, RGR values, and threshold comparisons used to generate the categorical result. This allows operators to review the data at different levels of granularity, depending on clinical or regulatory requirements.

The antibiotic effectiveness analysis can also be transmitted electronically to other computing devices, such as laboratory information systems (LIS), hospital information systems (HIS), or electronic medical record (EMR) systems, using standard data formats and communication protocols. In such cases, the computing device can package the S/I/R results with metadata, such as the bacterial species, test identification, cartridge identifier, and processing timestamp. This ensures that the results are integrated into broader clinical workflows and can be accessed by healthcare providers in real time.

In some implementations, the output may include additional interpretive flags or recommendations. For example, when resistance is detected to first-line antibiotics, the computing device can highlight alternative therapies tested in the panel. Likewise, when an invalid result is recorded for a particular antibiotic, the output can indicate that no valid interpretation was possible, prompting retesting or reflex to a reference method. By structuring the antibiotic effectiveness analysis in this way, the computing device provides not only categorical susceptibility outcomes but also the context necessary to guide accurate clinical decision-making.

We claim:

1. A method comprising:
receiving, by the computing device, a second sample image corresponding to a second sample of the biological specimen and a third sample image corresponding to a third sample of the biological specimen, wherein the second sample is not treated with the antibiotic and the third sample is treated with an antibiotic;
for each image of the second sample image and the third sample image, analyzing, by the computing device, the image to determine a blob count corresponding to the image;
determining, by the computing device, a growth ratio based on at least the blob count for each image of the second sample image and the third sample image; and
outputting, by the computing device and based on the growth ratio, an antibiotic effectiveness for biological specimen.

2. The method of claim 1, further comprising:
receiving, by a computing device, a first sample image corresponding to a first sample of a biological specimen; and
wherein:
the first sample image is included for analyzing each image to determine the blob count corresponding to the image; and
determining the growth ratio is further based on the blob count for the first sample image.

3. The method of claim 2, further comprising:
determining, by the computing device, the growth ratio exceeds a threshold, wherein the threshold indicates that a pathogen within the biological specimen is resistant to the antibiotic; and
wherein outputting the antibiotic effectiveness for the biological specimen includes indicating that the pathogen is resistant to the antibiotic.

4. The method of claim 2, further comprising:
determining, by the computing device, the growth ratio fails to exceed a threshold, wherein the threshold indicates that a pathogen within the biological specimen is resistant to the antibiotic; and
wherein outputting the antibiotic effectiveness for the biological specimen includes indicating that the pathogen is susceptible to the antibiotic.

5. The method of claim 2, wherein analyzing the image to determine the blob count further comprises:
identifying connecting pixels of the image to identify blobs;
counting the blobs to determine a total blob count;
identifying that one or more blobs are aberrant blobs; and
reducing, based on a count of the aberrant blobs, the total blob count to the blob count for the image.

6. The method of claim 2, wherein:
the first sample image is captured at a first time;
the second sample image and the third sample image are captured at a second time; and
there is a predetermined growth time period between the first time and the second time.

7. The method of claim 2, wherein the growth ratio is a first growth ratio and wherein the method further comprises:
receiving, by the computing device, a fourth sample image corresponding to a fourth sample of the biological specimen, wherein the fourth sample is treated with a high dosage of the antibiotic and the third sample is treated with a low dosage of the antibiotic;
analyzing, by the computing device, the fourth sample image to determine the fourth sample blob count;
determining, by the computing device, a second growth ratio based on at least the fourth sample blob count and the blob count for each image of the first sample image and the second sample image; and
wherein outputting the antibiotic effectiveness for the biological specimen is further based on the second growth ratio.

8. A method comprising:
receiving, by a computing device, a first sample image corresponding to a first sample of a biological specimen containing a targeted pathogen;
receiving, by the computing device:
a second sample image corresponding to a second sample of the biological specimen containing the targeted pathogen;
a third sample image corresponding to a third sample of the biological specimen containing the targeted pathogen, wherein the third sample is treated with a low dose of an antibiotic;
a fourth sample image corresponding to a fourth sample of the biological specimen containing the targeted pathogen, wherein the fourth sample is treated with a high dose of the antibiotic;
for each image of the first sample image, the second sample image, the third sample image, and the fourth sample image, analyzing, by the computing device, the image to determine a blob count;
determining, by the computing device, a first growth ratio based on at least the blob count for each image of the first sample image, the second sample image, the third sample image;
determining, by the computing device, a second growth ratio based on at least the blob count for each image of the first sample image, the second sample image, the fourth sample image; and
outputting, by the computing device and based on the first growth ratio and the second growth ratio, an antibiotic effectiveness for the biological specimen.

9. The method of claim 8, further comprising:
determining, by the computing device, the first growth ratio exceeds a threshold;
determining, by the computing device, the second growth ratio exceeds the threshold; and
wherein outputting the antibiotic effectiveness for the biological specimen includes indicating that the targeted pathogen is resistant to the antibiotic.

10. The method of claim 8, further comprising:
determining, by the computing device, the first growth ratio exceeds a threshold;
determining, by the computing device, the second growth ratio fails to exceed the threshold; and
wherein outputting the antibiotic effectiveness for the biological specimen includes indicating that the targeted pathogen is intermediate to the antibiotic.

11. The method of claim 8, further comprising:
determining, by the computing device, the first growth ratio fails to exceed a threshold;
determining, by the computing device, the second growth ratio fails to exceed the threshold; and
wherein outputting the antibiotic effectiveness of the biological specimen includes indicating that the targeted pathogen is susceptible to the antibiotic.

12. The method of claim 8, further comprising:
determining, by the computing device, the first growth ratio fails to exceed a threshold;
determining, by the computing device, the second growth ratio exceeds the threshold; and
wherein outputting the antibiotic effectiveness of the biological specimen includes indicating that susceptibility or resistance to the antibiotic is inconclusive.

13. The method of claim 8, wherein analyzing the image to determine the blob count further comprises:
identifying connecting pixels of the image to identify blobs;
counting the blobs to determine a total blob count;
identifying that one or more blobs are aberrant blobs; and
reducing, based on a count of the aberrant blobs, the total blob count to the blob count for the image.

14. The method of claim 8, wherein:
the first sample image is captured at a first time;
the second sample image, the third sample image, and the fourth sample image are captured at a second time; and
there is a predetermined growth time period between the first time and the second time.

15. A method comprising:
receiving, by a computing device, a first sample image corresponding to a first sample of a biological specimen containing a targeted pathogen;
receiving, by the computing device:
a second sample image corresponding to a second sample of the biological specimen containing the targeted pathogen;
a third sample image corresponding to a third sample of the biological specimen containing the targeted pathogen, wherein the third sample is treated with a first antibiotic;
a fourth sample image corresponding to a fourth sample of the biological specimen containing the targeted pathogen, wherein the fourth sample is treated with a second antibiotic;
for each image of the first sample image, the second sample image, the third sample image, and the fourth sample image, analyzing, by the computing device, the image to determine a blob count;
determining, by the computing device, a first growth ratio based on at least the blob count for each image of the first sample image, the second sample image, the third sample image;
determining, by the computing device, a second growth ratio based on at least the blob count for each image of the first sample image, the second sample image, the fourth sample image; and
outputting, by the computing device and based on the first growth ratio and the second growth ratio, an antibiotics effectiveness analysis for the biological specimen.

16. The method of claim 15, further comprising:
determining, by the computing device, the first growth ratio exceeds a first threshold, wherein the first threshold indicates that the targeted pathogen of the biological specimen is resistant to the first antibiotic;
determining, by the computing device, the second growth ratio exceeds a second threshold, wherein the second threshold indicates that the targeted pathogen of the biological specimen is resistant to the second antibiotic; and
wherein outputting the antibiotics effectiveness analysis for the biological specimen includes indicating that the targeted pathogen is resistant to the first antibiotic and the targeted pathogen is resistant to the second antibiotic.

17. The method of claim 15, further comprising:
determining, by the computing device, the first growth ratio exceeds a first threshold, wherein the first threshold indicates that the targeted pathogen of the biological specimen is resistant to the first antibiotic;
determining, by the computing device, the second growth ratio fails to exceed a second threshold, wherein the second threshold indicates that the targeted pathogen of the biological specimen is resistant to the second antibiotic; and
wherein outputting the antibiotics effectiveness analysis for the biological specimen includes indicating that the targeted pathogen is resistant to the first antibiotic and the targeted pathogen is susceptible to the second antibiotic.

18. The method of claim 15, further comprising:
determining, by the computing device, the first growth ratio fails to exceed a first threshold, wherein the first threshold indicates that the targeted pathogen of the biological specimen is resistant to the first antibiotic;
determining, by the computing device, the second growth ratio exceeds a second threshold, wherein the second threshold indicates that the targeted pathogen of the biological specimen is resistant to the second antibiotic; and
wherein outputting the antibiotics effectiveness analysis for the biological specimen includes indicating that the pathogen is susceptible to the first antibiotic and the pathogen is resistant to the second antibiotic.

19. The method of claim 15, further comprising:
determining, by the computing device, the first growth ratio fails to exceed a first threshold, wherein the first threshold indicates that the targeted pathogen of the biological specimen is resistant to the first antibiotic;
determining, by the computing device, the second growth ratio fails to exceed a second threshold, wherein the second threshold that indicates that the pathogen of the biological specimen is resistant to the second antibiotic; and
wherein outputting the antibiotics effectiveness analysis for the biological specimen includes indicating that the targeted pathogen is susceptible to the first antibiotic and the targeted pathogen is susceptible to the second antibiotic.

20. The method of claim 15, further comprising identifying morphological changes between the second sample and the third sample by analyzing the second sample image and the third sample image, and wherein outputting the antibiotics effectiveness analysis for the biological specimen further comprises indicating that third sample includes morphological changes when compared to the second sample.
